(19) United States
(12) Patent Application Publication
(10) Pub. No.: US 2011/0042468 A1
(43) Pub. Date: Feb. 24, 2011

(54) TEMPERATURE-CONTROLLED MIXED WATER AND COLD/HOT WATER SUPPLY SYSTEM

(75) Inventor: Yeong-Chun Lee, Bucheon-si (KR)

Correspondence Address: BOOTH UDALL, PLC, 1155 W. Rio Salado Pkwy., Suite 101, Tempe, AZ, 85281, US

(73) Assignee: PIP CO., LTD., Bucheon-si, Gyeonggi-do (KR)

(21) Appl. No.: 12/989,407

(22) PCT Filed: Apr. 23, 2009
(86) PCT No.: PCT/KR2009/002140

§ 371 Date: Oct. 22, 2010

(30) Foreign Application Priority Data
Apr. 23, 2008 (KR) 10-2008-37541
Apr. 29, 2008 (KR) 10-2008-39690

(51) Int. Cl. G05D 23/13

(52) U.S. Cl. 236/12.1

(57) ABSTRACT

[Technical Problem] The discharge of mixed hot and cold water by means of a manually operated faucet handle or a manual control valve is not convenient to get an optimum temperature as the temperature of discharged water varies from user to user, and because the temperature of discharged water changes while in use, users have to operate the faucet handle again until an optimum temperature is realized.

[Technical Solution] Meanwhile, the temperature-controlled mixed water and hot/cold water supply system of the present invention is designed to have start-up/stop control over a water heater and the control over a circulating water pump such that mixed water having a user-set temperature may be provided via respective water spouts that are installed in a shared bathroom, a kitchen, a private bathroom and a laundry room, respectively, thereby discharging mixed water having a preset temperature ready for immediate use.

### TECHNICAL FIELD

The present invention relates, in general, to hot/cold water supply systems in which the temperature of mixed water can be easily controlled and, more particularly, to a hot/cold water supply system for washstands or other water facilities installed in apartments, officetels, hotels, houses, saunas, public toilets, etc., in which, when both a circulating water pump start switch and a flow control lever of a water heater 12 installed around the entrance of a bathroom or in one side of a faucet 30 are operated such that the switch terminals of the water heater can be turned on and actuate a circulating water pump of the water heater, the system realizes circulation of water both through a mixed water pipe and through a circulating water pipe and discharges mixed water having a temperature preset by a user using a water temperature control switch out of faucets installed in a public bath, a kitchen, a private bath, a laundry room, etc., and which can save water unlike a conventional hot/cold water supply system configured such that cold water must be removed from a pipeline until hot water having a desired temperature controlled by manipulating the control lever of an integrated hot/cold water faucet upwards, downwards, leftwards and rightwards comes out of the faucet, thus consuming an excessive amount of water, and which can remarkably reduce energy consumption required to circulate hot water and can prevent a user from being burnt by hot water having an excessively high temperature heated by the water heater and directly discharged from the faucet by misoperation of the control lever of the integrated hot/cold water faucet unlike the conventional hot/cold water supply system in which, to allow a user to immediately use hot water discharged from a hot/cold/warm water faucet, separate circulating water pipes must be installed and both a water heater and a circulating water pump must be repeatedly turned on and off all day in response to signals output from a temperature sensor sensing the various temperatures, thus consuming excessive energy, and in which the problems experienced in the related art such that the temperature of hot water may frequently change in response to variations in the heating temperature of the water heater and may make a user feel discomfort while taking a bath or taking a shower bath can be solved, and in which mixed warm water having a predetermined temperature can be distributed to water distributing valve control boxes of respective control zones using one thermo valve formed by integrating a step motor with a thermostatic valve into a single structure, so that the present invention can supply mixed water having a desired temperature to a plurality of faucets using one thermo valve without separately mixing hot water with cold water for the respective faucets, and in which, when a user pushes a cold water/mixed water control switch, provided on one side of a faucet, when using hot water or mixed water, the cold water/mixed water control valves of the water distributing valve control boxes in respective control zones can be directly changed to a cold water mode, so that a user can easily select cold water or mixed water as desired, and which does not require the separate installation of a cold water pipe and a hot water pipe in a wall, but allows the user to install one hot water/mixed water pipe for supplying hot water or mixed water or one cold water pipe supplying cold water in one pipeline, thus immediately supplying hot/cold/mixed water as desired and reducing the number of required pipes constituting the pipeline, thus realizing stability of the floor slab structure, and in which the valve control boxes have a manifold structure, a water distributing function, a function of selectively discharging hot water, mixed water and cold water and have a double pipe structure without being affected by the installation heights of the control boxes or by the location of walls.

The present invention also relates to a hot/cold water supply system, in which a cleaning spray can be used instead of a conventional integrated type bidet in a way such that a mixed water pipe having a bellows double pipe structure is installed in a wall at a desired location outside a toilet bowl without installing a conventional integrated type bidet to the toilet bowl and a cleaning spray having both a flow control button and a metal spray hose is installed on the surface of the wall after finishing the interior finish work such that the cleaning spray is connected to the mixed water pipe, so that a user can wash his/her body after relieving himself (urinating or evacuating), using mixed water discharged from a valve control box of either a public bath control zone or a private bath control zone according to the selection of the user and in which the cleaning spray can be held on a cleaning spray holder installed on the wall and can be used for cleaning the floor of the toilet.

Further, the present invention further relates to a hot/cold water supply system, in which, when it is required to repair the pipes connected to respective control zones due to a leakage of water from the pipes or due to the requirement of having to change the existing pipes with new pipes, a worker can open the front door of an associated valve control box and remove the hot water/mixed water pipe, the cold water pipe or the circulating water pipe from out of the bellows double pipes connected to the valve control box without damaging or breaking the interior finish materials, and in which, unlike the conventional system having an integrated hot/cold water faucet installed on a wall, only a flow control lever for controlling the flow of discharged water is connected to a faucet, so that the system of the present invention can provide a smart wall surface having a good appearance.

### BACKGROUND ART

Conventional hot/cold water supply systems installed in apartments, officetels, hotels, houses, saunas, etc. supply cold water and hot water heated by a water heater 12 to a desired place in a way such that the hot water and the cold water are appropriately mixed together by manipulating the handle of an integrated hot/cold water faucet and are discharged to a user by the spout of the integrated hot/cold water faucet.

In the conventional hot/cold water supply system, a faucet handle or a manual control valve must be used to control the amount and temperature of mixed water discharged from the spout of the integrated hot/cold water faucet. When using the conventional system, a user must manually control the faucet handle or the manual control valve such that hot water and cold water mix together to produce mixed water at the desired temperature and the mixed water can be discharged by the spout of the integrated hot/cold water faucet.

The conventional hot/cold water supply system, in which the faucet handle or the manual control valve must be manually controlled to provide mixed water at the desired temperature, is problematic in that users differently control the temperatures of discharged water, so that it is difficult to appropriately control the temperature of the discharged water. Further, right after opening the faucet handle to use mixed water at the desired temperature, the water having a low temperature remaining in the hot water pipe and cold water remaining in the cold water pipe mix together, so that the discharged water in the initial stage of the operation of the system can not achieve the desired temperature. Therefore, a user must control the faucet handle repeatedly to realize the desired temperature of the discharged water while using the mixed water. Further, when a user carelessly manipulates the faucet handle such that the handle has been turned to the peak of the hot water mode or of the cold water mode, hot water having a very high temperature or cold water is undesirably discharged from the spout so that the user may be burned by the hot water or may be startled at the cold water.

Another problem experienced in the conventional system resides in that the system must be provided with a faucet handle or a manual control valve for controlling the amount and temperature of discharged water, cold water supply pipes for supplying cold water, and hot water supply pipes for supplying hot water so that it is difficult to install them in a wall and the faucet handle spoils the appearance of the wall.

### DESCRIPTION OF DRAWINGS

FIG. 1 is a block diagram schematically illustrating the construction of a hot/cold water supply system according to the first embodiment of the present invention;

FIG. 2 is a view schematically illustrating the piping of the hot/cold water supply system according to the first embodiment of the present invention;

FIG. 3 is an enlarged view illustrating both a circulating water pumping control zone and a distribution control zone according to the first embodiment of the present invention;

FIG. 4 is an enlarged perspective view illustrating a thermo valve according to the first embodiment of the present invention;

FIG. 5 is an enlarged perspective view illustrating a manifold pipe installed in a valve control box of a kitchen control zone according to the first embodiment of the present invention;

FIG. 6 is an enlarged perspective view illustrating a manifold pipe installed in a valve control box of a public bath control zone according to the first embodiment of the present invention;

FIG. 7 is a view illustrating a laundry room valve control box according to the first embodiment of the present invention;

FIG. 8 is a block diagram showing a control system for controlling the hot/cold water supply system by a main control zone according to the first embodiment of the present invention;

FIG. 9 is a view schematically illustrating the piping of a hot/cold water supply system according to a modification of the first embodiment of the present invention;

FIG. 10 is a view schematically illustrating the piping of a hot/cold water supply system according to the second embodiment of the present invention;

FIG. 11 is an enlarged view of a circulating water pumping control zone according to the second embodiment of the present invention;

FIG. 12 is a circuit diagram illustrating the electric connection of a circulating water pump start switch according to the second embodiment of the present invention;

FIG. 13 is an enlarged perspective view of a distribution control zone according to the second embodiment of the present invention;

FIG. 14 is an enlarged perspective view of a distribution control box having a thermo valve according to the second embodiment of the present invention;

FIG. 15 is a perspective view illustrating a public bath control zone which is one of the control zones connected to the distribution control zone according to the second embodiment of the present invention;

FIG. 16 is a view illustrating the flow of cold water or mixed water passing through a shutoff valve under the control of a shutoff lever according to the second embodiment of the present invention;

FIG. 17 is a perspective view illustrating a kitchen control zone which is one of the control zones connected to the distribution control zone according to the second embodiment of the present invention;

FIG. 18 is a perspective view illustrating a distribution control box constituting the distribution control zone according to a modification of the second embodiment of the present invention;

FIG. 19 is a perspective view illustrating a valve control box constituting a control zone according to a modification of the second embodiment of the present invention;

FIG. 20 is a view illustrating series piping according to the second embodiment of the present invention; and

FIG. 21 is a view illustrating series piping according to a modification of the second embodiment of the present invention.

### DISCLOSURE

### Technical Problem

Accordingly, the present invention has been made keeping in mind the above problems occurring in the related art, and the present invention is intended to propose a hot/cold water supply system, in which the water temperature can be easily controlled and mixed water having a desired temperature selected by a user can be immediately discharged from respective faucets 30 installed in a public bath, a kitchen, a private bath, a laundry room, etc. by controlling the operation of a water heater and a circulating water pump 15, so that the user can use mixed water without feeling any discomfort as a result of the temperature of the hot water frequently changing in response to variations in the amount of cold water that is used, and the user can be prevented from being burned by hot water having a very high temperature, and a circulating water pump can be prevented from being uselessly operated, thus saving on water and energy, and in which valve control boxes provided in respective control zones have a bellows double pipe structure with respective flexible pipes, such as a cold water pipe, a hot water pipe, a mixed water pipe, a circulating water pipe inserted in respective bellows outer pipes such that the flexible pipes can be removed from the valve control boxes, thus realizing easy repair of the flexible pipes and easy replacement of the existing flexible pipes with new pipes, and in which the cold water/mixed water control valves installed in respective valve control boxes can stop the flow of hot water and mixed water, so that it is easy to repair pipes in the case of faucets breaking or water leaking from the pipes extending to a washstand, a toilet bowl, a bathtub, a shower head, a sink, an automatic washing machine, a hand washing facility, etc., and in which a hot water/mixed water pipe for supplying hot water/mixed water and a cold water pipe for supplying cold water are installed on one pipeline, so that hot water, mixed water or cold water can be immediately discharged to the user, thus reducing the number of pipes and realizing the stability of a floor slab structure, and in which a cleaning spray having both a flow control button 63 and a metal spray hose and connected to a mixed water pipe is installed on the surface of a wall around a toilet bowl without installing a conventional integrated type bidet to the toilet bowl, so that a user can wash his/her body after relieving oneself (i.e., urinating or evacuating) using mixed water distributed from the valve control boxes 41a and 41b of a public bath control zone and a private bath control zone according to the selection of the user, and the cleaning spray held on a cleaning spray holder installed on the wall can be used for cleaning the floor of the toilet.

### Technical Solution

In an aspect, the present invention provides a hot/cold water supply system comprising: a circulating water pumping control zone 10 for controlling operation of a water heater 12 and a distribution control zone 11, in which a three-way valve 13, a pressure sensor 14 and a circulating water pump 15 are installed at locations below the water heater 12 heating cold water such that they are exposed outside, and a cold water distributing pipe 16 for distributing cold water and a hot water distributing pipe 17 for distributing hot water are provided, and the distribution control zone 11 having a plurality of thermo valves 18 each fabricated by integrating a step motor 18a with a thermostatic valve 18k into a single structure is provided at a location below the cold water and hot water distributing pipes 16 and 17, wherein, when both a circulating water pump start switch 19 of the water heater 12 and a flow control lever 31, which are installed at locations around the entrance of a bathroom or a faucet 30, are operated, the switch terminals of the water heater 12 and the circulating water pump 15 are activated to operate both the water heater 12 and the circulating water pump 15, thus realizing circulation of water through both a mixed water pipe 20 and a circulating water pipe 21 and immediately discharging mixed water, at the temperature preset by a user using the temperature control switch 22, out of respective faucets 30 installed in a public bath, a kitchen, a private bath and a laundry room, thereby preventing a user from being burned by hot water that is at a very high temperature and cutting back on water and energy usage; a plurality of control zones 40, 40a and 40b, which have respective valve control boxes 41, 41a and 41b provided with cold water/mixed water control valves 43 for receiving cold water and mixed water that are at preset temperatures from the circulating water pumping control zone 10 and controllably distributing water by operation of a motor 45, and a control switch box 44 provided at an appropriate location around each of the valve control boxes 41, 41a and 41b and shifting the cold water/mixed water control valve 43 to a cold water mode or to a mixed water mode, and provided with both a temperature control switch 22 and a circulating water pump start switch 19 for setting the desired temperature of the discharged mixed water; a plurality of faucets 30 each provided with both a flow control lever 31 and a hot/cold water control lever 32 for controlling the discharge of cold water or mixed water supplied from one of the control zones 40, 40a and 40b; and a main control zone 70 having a controller 72 electrically and electronically connected to the circulating water pumping control zone 10, the respective control zones 40, 40a and 40b and the faucets 30, and controlling operation of the water heater 12 and the amount and temperature of mixed water when using hot water or mixed water, wherein the control zones 40, 40a and 40b are connected to each other in parallel such that cold water pipes 23 supplying cold water to the respective control zones 40, 40a and 40b are connected to each other in a loop parallel style.

### ADVANTAGEOUS EFFECTS

As described above, in the present invention having the above-mentioned construction, the amount and temperature of hot water selected by a user using a temperature control switch provided in control zones can be automatically controlled, so that water having a desired temperature can be immediately discharged by faucets installed in a public bath, a kitchen, a private bath and a laundry room, thus preventing the user from being burned by hot water having a very high temperature. Further, respective control zones can be controlled by a main control zone, so that the plurality of faucets installed in respective control zones can be easily controlled, thus realizing easy installation and usage of the system. Further, when a circulating water pump start switch installed at a location around the entrance of a bathroom or around a faucet is operated before using the mixed water, the switch terminals of the water heater are turned on, so that the water heater is started and hot water/mixed water at the desired temperature can circulate from the mixed water pipe to the circulating water pipe under the control of the thermo valves installed in respective control zones. Further, when hot water/mixed water is discharged from an open faucet, the terminals of the pressure sensor are turned off, so that the operation of the circulating water pump in the circulating water pipe is stopped and the flow of water through the circulating water pipe is also stopped. However, when mixed water discharged from the faucet is continuously used, the water heater continues to operate. When the flow control lever of the faucet is closed, the operation of the water heater is stopped, thus saving on electricity and the fuel used to create the energy. Further, in the system of the present invention, mixed water can be immediately discharged without uselessly discharging cold water, so that the present invention can save on water. In the present invention, it is not necessary to separately install a hot water faucet handle, a cold water faucet handle and a mixed water faucet handle to control the faucets installed in respective control zones, so that the number of seamed parts in pipes and faucets can be reduced and the structure of the pipes and faucets installed in respective control zones is simple, thus providing a smart wall surface having a good appearance. Further, a cleaning spray can be used instead of a conventional integrated type bidet in a way such that a mixed water pipe having a bellows double pipe structure is installed in a wall at a desired location outside a toilet bowl without installing a conventional integrated type bidet to the toilet bowl and a cleaning spray having both a flow control button and a metal spray hose is installed on the surface of the wall after finishing the interior finish work such that the cleaning spray is connected to the mixed water pipe, so that a user can wash the desired part of his/her body after relieving himself (i.e., urinating or evacuating) using mixed water distributed from a valve control box of either a public bath control zone or a private bath control zone according to the selection of the user. The cleaning spray can be held on a cleaning spray holder installed on the wall and can be used to clean the bottom of the toilet.

### BEST MODE

### First Embodiment

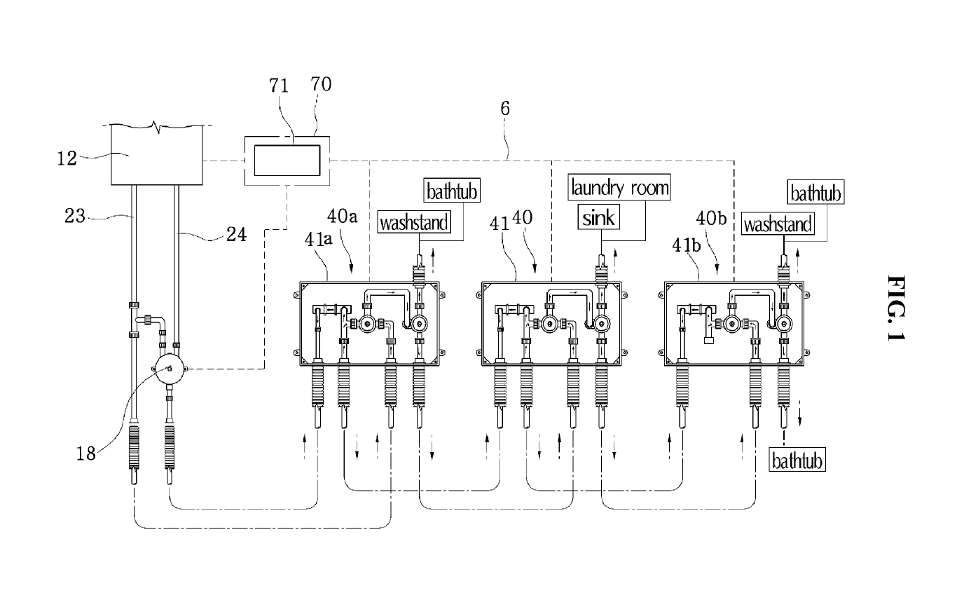

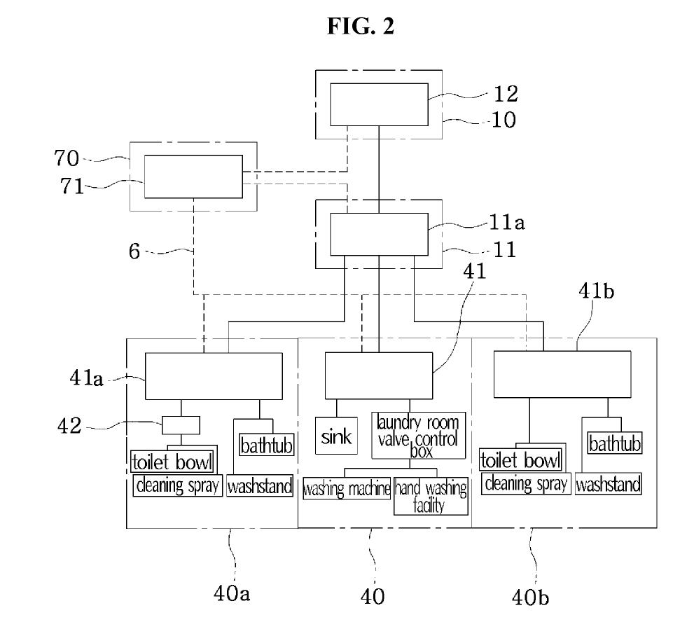

FIG. 1 is a block diagram schematically illustrating a hot/cold water supply system according to the first embodiment of the present invention. FIG. 2 is a view schematically illustrating the construction of the hot/cold water supply system according to the first embodiment of the present invention.

Hereinbelow, the present invention will be described in detail with reference to the drawings.

In the present invention, the hot/cold water supply system of the present invention includes: a circulating water pumping control zone 10, in which a pressure sensor 14 and a hot water/circulating water pump 15 having a three-way valve are installed on respective pipes extending from the water heater 12, so that, when using hot water, circulation of hot water and circulating water can be controlled by turning on a circulating water pump start switch 19, and when using hot water exclusively, the water heater and the hot water/circulating water pump 15 are operated to supply hot water so that mixed water can be instantaneously discharged, thus saving on water and energy; a distribution control zone 11, which includes a cold water distributing pipe 16 for distributing cold water discharged from the cold water pipe 23, a hot water distributing pipe 17 for distributing hot water discharged from the hot water pipe 24, and a distribution control box 11a provided with a plurality of thermo valves 18 each fabricated by integrating a step motor 18a with a thermostatic valve 18k; a plurality of control zones 40, 40a and 40b, which include respective valve control boxes 41, 41a and 41b having respective temperature setting levers 82 controlling the step motors 18a of the respective thermo valves 18 such that the temperature of mixed water discharged from the distribution control zone 11 can be controlled, respective cold water/mixed water control valves 43 for distributing mixed water and cold water at predetermined temperatures, and respective shutoff valves 43′ for controlling the flow of discharged water; a plurality of faucets 30 having respective flow control levers and respective cold water/mixed water control levers 64 controlling the flow of mixed water and cold water supplied from the control zones 40, 40a and 40b; and a main control zone having a controller 72 electrically and electronically connected to the circulating water pumping control zone 10, the distribution control zone 11 and the respective control zones 40, 40a and 40b and controlling operation of the water heater 12 and the temperature of the mixed water when using the hot water/mixed water, wherein the respective control zones 40, 40a and 40b are coupled to each other in parallel, so that, when the circulating water pump start switch 19 is operated, the three-way valve 13 is opened both toward the circulating water pipe 21 and toward the hot water pipe 24, and both the water heater 12 and the circulating water pump 15 are activated, and thereby hot water heated in the water heater 12 flows to the thermo valves 18 through the hot water pipe 24 and produces mixed water at a predetermined temperature and is discharged by the faucets 30, and wherein, when the faucets 30 are opened, pressure inside a pipeline is reduced and terminals of the pressure sensor 14 are turned off, so that openings of the three-way valve 13 toward both the circulating water pipe 21 and the hot water pipe 24 are closed and, at the same time, the three-way valve 13 is opened in the direction of the hot water pipe 24 by way of both the cold water pipe 23 and a hot water heating coil installed in the water heater 12, so that hot water/mixed water can be continuously discharged, and wherein, when the flow control levers 31 provided in the faucets 30 are closed, the operation of the water heater 12 is stopped, so that the mixed water can be immediately discharged without uselessly consuming cold water, thereby saving on water.

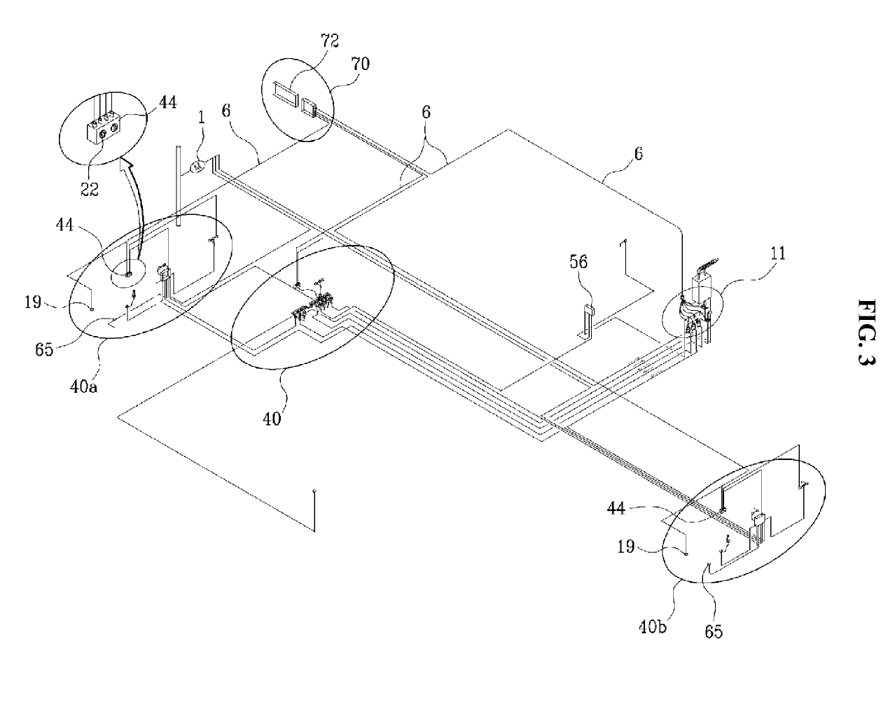

As shown in FIG. 3, the circulating water pumping control zone 10 includes the three-way valve 13, the pressure sensor 14, the circulating water pump 15, the cold water distributing pipe 16 for distributing cold water, and the hot water distributing pipe 17 for distributing hot water heated by the water heater 12 at predetermined locations below the water heater 12 heating cold water supplied thereto by the cold water pipe 23.

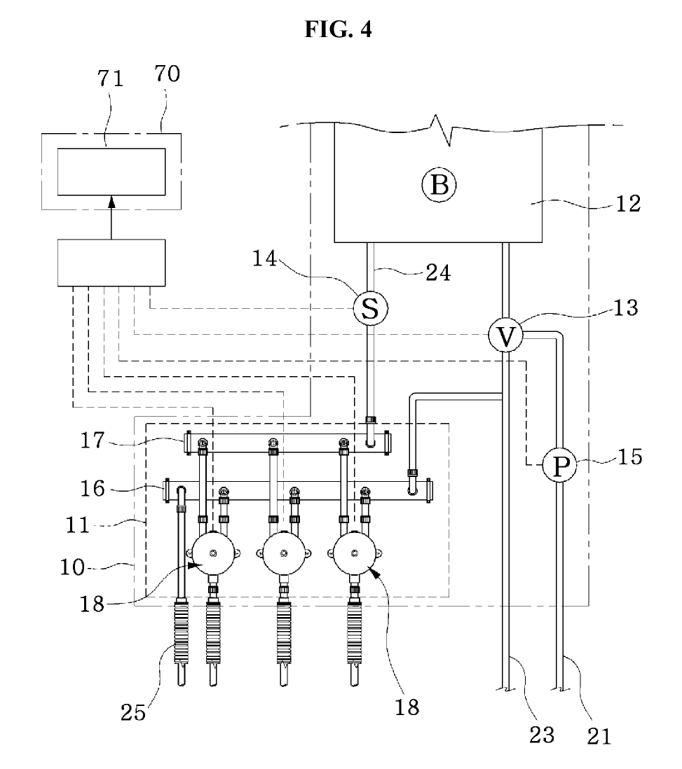

A plurality of thermo valves 18 are installed at locations below the cold water distributing pipe 16 and the hot water distributing pipe 17. As shown in FIG. 3 and FIG. 4, each thermo valve 18 is produced by integrating a step motor 18a with a thermostatic valve 18k into a single structure, and forms a distribution control zone 11, which can receive cold water and hot water from the cold water and hot water distributing pipes 16 and 17, respectively, and mixes the cold water with the hot water, thus producing mixed water prior to distributing the mixed water to the respective control zones 40, 40a and 40b.

In each thermo valve 18, a five-phase or multi-phase step motor 18a is integrated with both a thermostatic valve 18k using a bracket 18c into a single structure. The step motors 18 can be activated by DC power and are electrically connected both to the controller 72 of the main control zone 70 and to the temperature control switches 22 provided in the control switch boxes 44 of the respective control zones 40, 40a and 40b using electric wires 6, so that the step motors 18 can be controlled by both the controller 72 and the respective temperature control switches 22.

Therefore, when the circulating water pump start switch 19 of the water heater 12 installed at a location around a desired place or at a location around a faucet 30 and a flow control lever 31 provided in the faucet 30 are operated, the terminals of the circulating water pump 15 of the water heater 12 are turned on, so that the circulating water pump 15 of the water heater 12 is started, thus circulating water through both the mixed water pipe 20 and the circulating water pipe 21. Therefore, mixed water at a temperature preset by a user using the temperature control switch 22 flows to the respective faucets 30 through the thermo valves 18 and can be discharged by the respective faucets 30 installed in a public bath, a kitchen, a private bath and a laundry room forming the respective control zones 40, 40a and 40b. Therefore, the present invention can prevent users from being burned by hot water at a very high temperature and can efficiently control the water heater 12 such that the system can save on water and energy.

When a predetermined time (several minutes) goes by after the circulating water pump start switch 19 has been turned on, the switch 19 is automatically turned off and stops mixed water from being discharged from the faucet 30. In the above state, pressure inside the pipeline is increased, so that, although the terminals of the pressure sensor 14 are kept in an activated state, both the water heater 12 and the circulating water pump 15 are stopped.

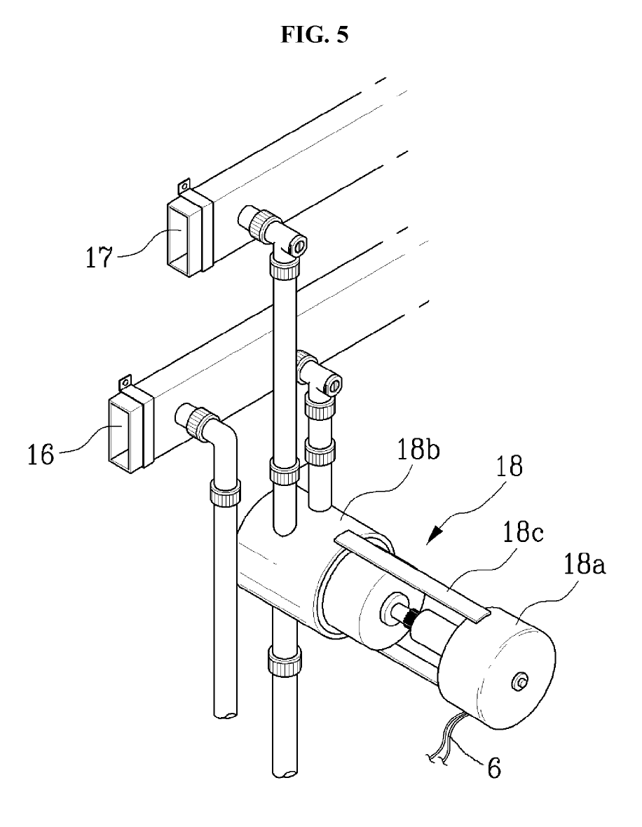

The cold water and the mixed water at the temperatures preset by the circulating water pumping control zone 10 are supplied to the manifold pipe 42 having the cold water/mixed water control valve 43, which is installed in the valve control box 41 constituting the kitchen control zone 40. As shown in FIG. 5, the valve control box 41 is provided with a hot water/mixed water branching pipe 47 and a cold water branching pipe 48 having a plurality of inlet/outlet ports 46 inside the valve control box 41. In the center of the manifold pipe 42 installed in the valve control box 41, the cold water/mixed water control valve 43 having a motor 45 is provided.

The inlet/outlet ports 46 provided on the hot water/mixed water branching pipe 47 of the manifold pipe 42 are connected to a hot water/mixed water pipe 20, a balcony hot water/mixed water supply pipe 49 and a sink water circulating pipe 50. The inlet/outlet ports 46 provided on the cold water branching pipe 48 of the manifold pipe 42 are connected to cold water pipes 23 extending to a public bath, a private bath and a balcony.

The hot water/mixed water pipe 20, the sink water circulating pipe 50 and the plurality of cold water pipes 23 are connected to respective ports by elbow couplings 51.

In one side of the hot water/mixed water branching pipe 47 connected to the sink water circulating pipe 50, a circulating water joining pipe 52 having a plurality of outlet ports 46a is provided. A main circulating water pipe 21 extending to the water heater 12 and a plurality of circulating water pipes 21 respectively extending to the public bath and to the private bath are connected to the outlet ports 46a of the circulating water joining pipe 52 using respective elbow couplings 51.

Here, check valves 53 are installed between the plurality of outlet ports 46a and the elbow couplings 51 connected to the plurality of circulating water pipes 21, thus preventing the circulating water from reversing its flow.

On the wall in which the valve control box 41 is installed, a control switch box 44 is installed at an appropriate location which users can easily reach while moving around the sink. The control switch box 44 has both a temperature control switch 22 and a circulating water pump start switch 19 and is used to select a desired temperature of discharged mixed water.

As described above, mixed water and cold water supplied from the cold water/mixed water control valve 43 of the valve control box 41 can be supplied to a sink faucet 30.

Here, the pipe extending from the cold water/mixed water control valve 43 to the sink faucet 30 uses a flexible pipe.

The faucet 30 is provided with both a flow control lever 31 and a hot/cold water control lever 32.

Further, hot water or mixed water supplied from the balcony hot water/mixed water supply pipe 49 mounted to the hot water/mixed water branching pipe 47 is supplied to a laundry room faucet 30.

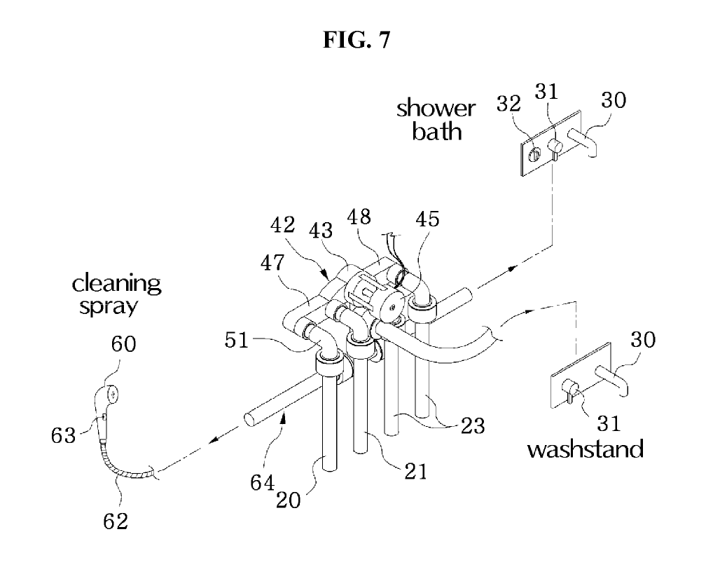

As shown in FIG. 7, a cold water/mixed water control valve 43 connected both to a cold water pipe 23 and to a mixed water pipe 20 is installed in a laundry room valve control box 56 and controls the flow of cold water and mixed water to the laundry room faucet 30. In front of the laundry room valve control box 56, an outer cover 57 having a washing machine faucet 30 is installed. If desired, an inner cover 58 may be installed. The inner cover 58 has an approach opening 58a for allowing the easy approach of a worker's hand or a working tool when it is required to repair the parts inside the laundry room valve control box 56, because of for example water having leaked, after finishing the interior finish work. Further, a plurality of frictional protrusions 58b may be formed on the outer surface of the inner cover 58 and allows mortar or tiles to be easily attached to the inner cover 58.

Further, at a desired location on a wall in one side of the laundry room valve control box 56, an elbow head 34 is installed. A hand washing faucet 30, which has a faucet handle and discharges mixed water and cold water for hand washing, is mounted to the elbow head 34.

Each of the control switch boxes 44, which is installed around an associated valve control box 41, 41a or 41b and has both a temperature control switch 22 and a circulating water pump start switch 19, is installed at an appropriate location, to which users can easily reach while moving in, for example, a kitchen and is used for selecting the desired temperature of discharged mixed water. For example, in a kitchen, the control switch box 44 may be installed on the wall at a location above a sink. Further, an additional switch having a variety of functions may be installed in each of the control switch boxes 44.

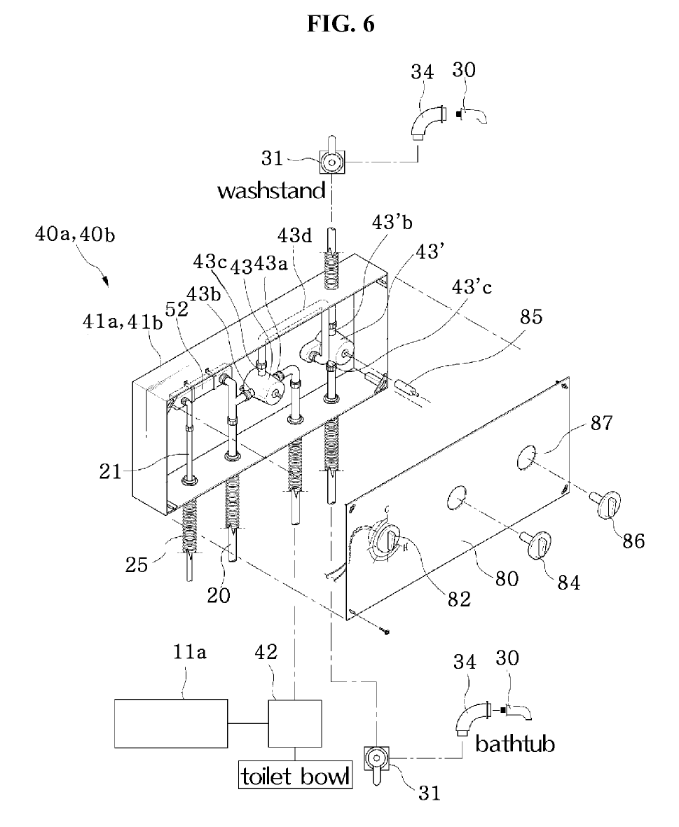

FIG. 6 is a view illustrating the manifold pipe 42 installed in the valve control box 41a of the public bath control zone 40a. As shown in the drawing, cold water and mixed water distributed by the valve control box 41a of the kitchen control zone 40 may be supplied to the valve control box 41a of the public bath control zone 40a.

In the valve control box 41a of the public bath control zone 40a, a manifold pipe 42 having the same or similar function as or to that of the manifold pipe 42 installed in the valve control box 41 of the kitchen control zone 40. As shown in FIG. 6, a hot water/mixed water branching pipe 47 and a cold water branching pipe 48 having a plurality of inlet/outlet ports 46 are provided in the valve control box 41a. Further, a manifold pipe 42 is provided in the valve control box 41a. In the center of the manifold pipe 42, a cold water/mixed water control valve 43 having a motor 45 is provided.

Both a hot water/mixed water pipe 20 extending to the water heater 12 and a circulating water pipe 21 by which hot water/mixed water circulates are connected to the inlet/outlet ports 46 provided on the hot water/mixed water branching pipe 47 of the manifold pipe 42. In the same manner, a plurality of cold water pipes 23 respectively extending to a main faucet, a kitchen faucet and a toilet 65 are mounted to the inlet/outlet ports 46 of the cold water branching pipe 48.

Further, at an appropriate location below the manifold pipe 42, a branching pipe 64 is provided for distributing cold water, hot water and mixed water to the cleaning spray 60, a bathtub, a shower bath and a washstand.

The cleaning spray 60 can be used instead of a conventional integrated type bidet in a way such that a mixed water pipe having a bellows double pipe structure is installed in the wall at a desired location outside a toilet bowl without installing a conventional integrated bidet to the toilet bowl 65 and the cleaning spray having both a flow control button 63 and a metal spray hose 62 is installed on the surface of the wall after finishing the interior finish work such that a user can wash the desired part of his/her body after relieving oneself (i.e., urinating or evacuating) using mixed water discharged from a valve control box 41a according to the selection of the user. The cleaning spray can be used to clean the bottom of the toilet as desired.

The cleaning spray 60 is provided with the flow control button 63, so that a user can easily wash his/her body or the floor of a bathroom or a toilet using mixed water by controlling the flow control button 63.

Further, mixed water or cold water supplied from the cold water/mixed water control valve 43 of above-mentioned valve control box 41a, 41b is distributed through the branching pipe 64 to the cleaning spray 62. An elbow head 34 having a flow control lever 31 controlling the flow of mixed water or cold water is installed in a wall. A faucet 30 is mounted to the elbow head 34 and discharges cold water/mixed water to a washstand or for a shower bath.

Here, the pipe extending from the cold water/mixed water control valve 43 to the washstand faucet 30 uses a flexible pipe.

Further, each of the control switch boxes 44, which is installed around an associated valve control box 41, 41a or 41b and has both a temperature control switch 22 and a circulating water pump start switch 19, is installed at an appropriate location, to which users can easily reach while moving around, for example, a washstand or a bathtub, and is used for selecting a desired temperature of discharged mixed water. For example, the control switch box 44 may be installed at a location, in which the control switch box 44 does not interfere with users moving around the washstand or the bathtub. Further, an additional switch having a variety of functions may be installed in the control switch box 44.

The piping for the faucet 30, which is connected to both the control switch box 44 and the manifold pipe 42 installed in the valve control box 41 of the private bath control zone 40b, remains the same as that described for the public bath control zone 40a and thus further explanation is not necessary.

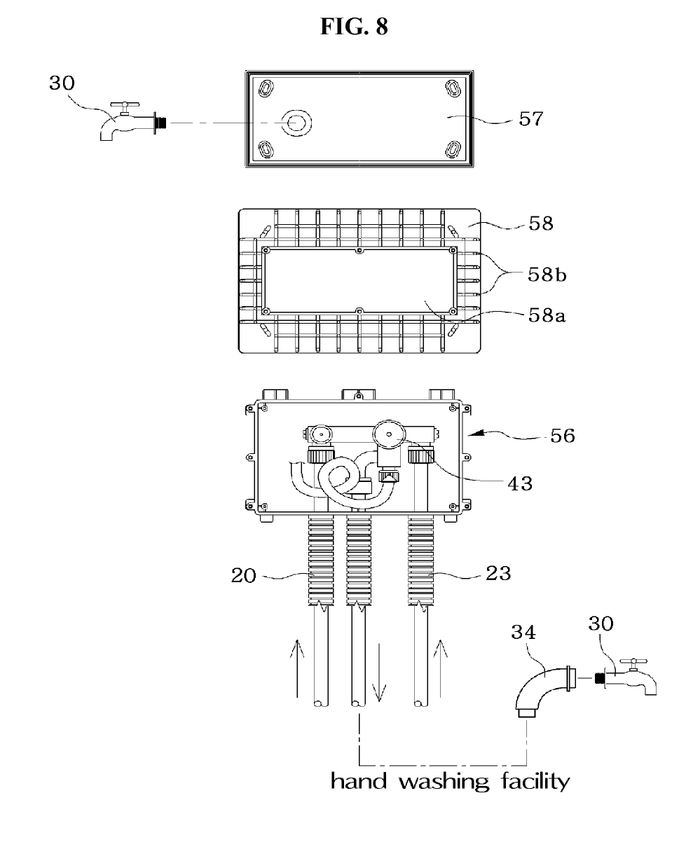

FIG. 8 is a block diagram illustrating the control system for controlling the hot/cold water supply system by the main control zone according to the present invention. As shown in the drawing, the main control zone 70, which has a controller 72 and controls both the operation of the water heater 12 and the amount and temperature of mixed water, is electrically and electronically connected to a water gauge box 1 connected to the cold water pipe 23, the step motor 18a of the thermo valve 18, the three-way valve 13 and the temperature control switches 22 cooperated with the respective control zones 40, 40a and 40b.

In the present invention, the cold water pipes 23 of the respective control zones 40, 40a and 40b are connected to each other in a loop parallel style, so that cold water from a main service water pipe can be supplied to all of the water heater 12, the public bath control zone 40a and the private bath control zone 40b at the same time. Therefore, when two or more faucets 30 in one house are simultaneously discharging cold water, the water supply system of the present invention can supply cold water in two directions, thus minimizing the variation in the flow rate of cold water.

Therefore, in the hot/cold water supply system of the present invention, when a predetermined time goes by after the circulating water pump start switch 19 installed in the control switch box 44 has been turned on, the switch 19 is automatically turned off and stops discharge of hot water/mixed water from the faucet 30. In the above state, pressure inside the pipeline is increased, so that, although the terminals of the pressure sensor 14 are kept in an activated state, both the water heater 12 and the circulating water pump 15 are stopped.

At appropriate locations below the water heater 12, a circulating water pump 15, a three-way valve 13 and a pressure sensor 14 are installed. When the circulating water pump start switch 19 of the control switch box 44 is turned on, the three-way valve 13 opens the pipeline toward both the circulating water pipe 21 and the hot water pipe 24. In the above state, because the water heater 12 and the circulating water pump 14 are operated, hot water heated by the hot water heating coil (not shown) installed in the water heater 12 is discharged to the thermo valve 18 through the hot water pipe 24 and circulates through both the hot water pipe 24 and the circulating water pipe 21, so that hot water or mixed water having a desired temperature can be discharged to a user through the faucet 30. When the faucet 30 is opened, pressure inside the pipeline is reduced, so that the terminals of the pressure sensor 14 are turned off and the openings of the three-way valve 13 towards both the circulating water pipe 21 and the hot water pipe 24 are closed. In the above state, the three-way valve 13 is opened toward the hot water pipe 24 by way of both the cold water pipe 23 and the hot water heating coil of the water heater 12, so that hot water or mixed water can be continuously supplied. When the flow control lever 31 of the faucet 30 is closed and the operation of the water heater 12 is stopped, mixed water can be discharged without uselessly consuming cold water, thereby saving water. Further, the water heater 12 can be repeatedly operated and stopped all day according to the predetermined temperature of hot water, thus restricting the consumption of electricity and fuel and thereby saving energy.

Each of the valve control boxes 41 of the respective control zones 40, 40a and 40b may be installed in a wall. Alternatively, each of the valve control boxes 41 may be installed in a ceiling panel of a toilet such that the valve control box 41 is exposed outside the ceiling panel. As a further alternative, each of the valve control boxes 41a may be installed in a wall at an appropriate location below a cupboard of a sink, a wardrobe or a wall closet in a dress room such that the valve control box 41 is exposed outside the wall. Of course, the valve control box 41 may be installed in the floor of a room.

Each of the pipes connected to the respective valve control boxes is fabricated in the form of a bellows double pipe 25 and is connected a valve control box using a connector (not shown). A cold water pipe, a hot water/mixed water pipe and a circulating water pipe, which are made of flexible pipes, are inserted in the outer pipe of the bellows double pipe 25 such that the flexible pipes can be easily removed from the outer pipes through the valve control boxes 41, 41a and 41b. In each of the valve control boxes 41, a cold water/mixed water control valve 43 is installed. The cold water/mixed water control valve 43 is operated by a motor 45 and controls the flow of water such that cold water, hot water or mixed water can be selectively discharged. Therefore, the water supply system of the present invention can supply cold water, hot water or mixed water from the cold water/mixed water control valve 43 to the respective faucets 30 and can selectively stop the flow of water to a faucet 30 when necessary, so that, when there occurs a breakage of a faucet 30 or a leakage of water from a pipe in a control zone 40, 40a or 40b related to a washstand, a toilet, a bathtub, a shower bath, a sink, an automatic washing machine or a hand washing facility, only the pipe to be repaired or associated to the broken faucet may be closed, so that it is easy to repair the faucet or the pipe unlike a conventional water supply system, in which, prior to executing repairing work, the inlet valve of the water gauge box 1 must be closed, thus stopping the flow of water to all the faucets installed in respective rooms in a house and giving discomfort to the residents of the rooms. Further, the valve control boxes 41, 41a and 41b have a variety of water pipes, such as the cold water pipe, the hot water/mixed water pipe and the circulating water pipe and the pipes of the valve control boxes 41, 41a and 41b can branch such that the pipes can be connected to the faucet 30 in another control zone in a loop parallel style.

Further, a cleaning spray having both a flow control button and a metal spray hose is installed on a wall at a desired location outside a toilet bowl. The cleaning spray can discharge mixed water supplied from the valve control boxes 41, 41a and 41b according to a selection of the user, thus being used for washing the body of a user after relieving oneself, such as urinating or evacuating, or for cleaning the floor of a toilet. Therefore, the water supply system of the present invention does not require a conventional integrated type bidet installed to a toilet bowl.

In the present invention, a hot water/mixed water pipe for supplying hot water/mixed water or a cold water pipe for supplying cold water can be installed on one pipeline in a wall having faucets 30 associated with respective control zones 40, 40a and 40b without separately installing the cold water pipe 23 or the mixed water pipe 20, so that hot water, mixed water or cold water can be immediately discharged to a user. Therefore, it is possible to immediately use hot water, mixed water or cold water, thus reducing the number of pipes and realizing the stability of a floor slab structure.

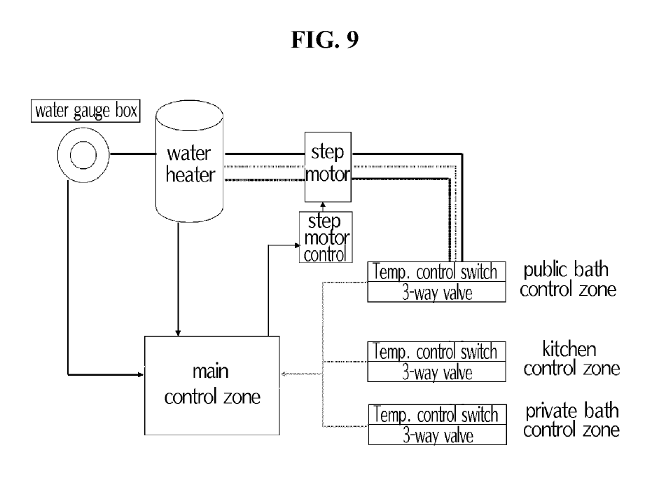

FIG. 9 is a view schematically illustrating the piping of a hot/cold water supply system according to a modification of the first embodiment of the present invention. As shown in the drawing, the hot/cold water supply system includes: a water heater 12, which heats cold water and produces hot water; a distribution control zone 11a, which is provided with a cold water distributing pipe 16 for distributing cold water supplied from a cold water pipe 23, a hot water distributing pipe 17 for distributing hot water heated by the water heater 12, and a plurality of manually operated thermo valves 18 for controlling the temperature of discharged water; and a plurality of control zones 40, 40a and 40b, which have respective valve control boxes 41 provided with cold water/mixed water control valves for receiving mixed water from the thermo valves 18 of the distribution control zone 11a and receiving cold water from the cold water pipe 23 and distributing cold water and mixed water to a plurality of faucets 30.

The hot/cold water supply system according to the modification of the first embodiment of the present invention can control the temperature of discharged water by manually operating the thermo valves 18 without using electricity. Further, only the cold water pipe 23 and the hot water pipe 24 are directly connected to the water heater 12, thus providing a simple hot/cold water supply system that can be easily installed. Therefore, the hot/cold water supply system can save the piping materials and can realize a simple and easy installation process.

### MODE FOR INVENTION

### Second Embodiment

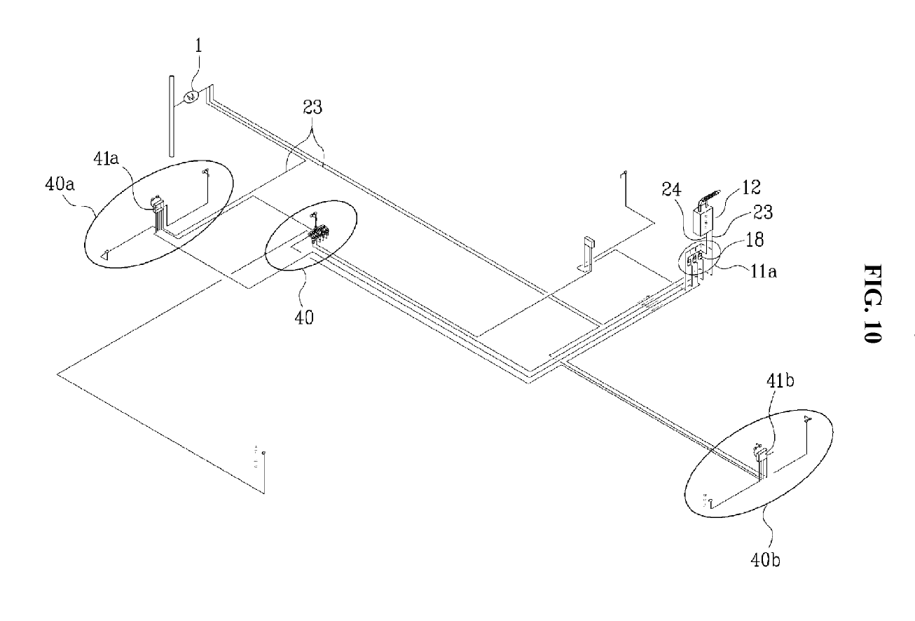

FIG. 10 is a view schematically illustrating the piping of a hot/cold water supply system according to the second embodiment of the present invention.

Hereinbelow, the hot/cold water supply system of a water heater 12 according to the second embodiment of the present invention will be described in detail with reference the accompanying drawings.

FIG. 10 illustrates the piping of a hot/cold water supply system installed in a house or an apartment. As shown in the drawing, the hot/cold water supply system includes a circulating water pumping control zone 10 and a distribution control zone 11, which are connected to each other through a circulating water pipe 21, a cold water pipe 23 and a hot water pipe 24. The hot/cold water supply system further includes a plurality of control zones 40, 40a and 40b, which are connected to the distribution control zone 11 through a circulating water pipe 21, a mixed water pipe 20 and the cold water pipe 23.

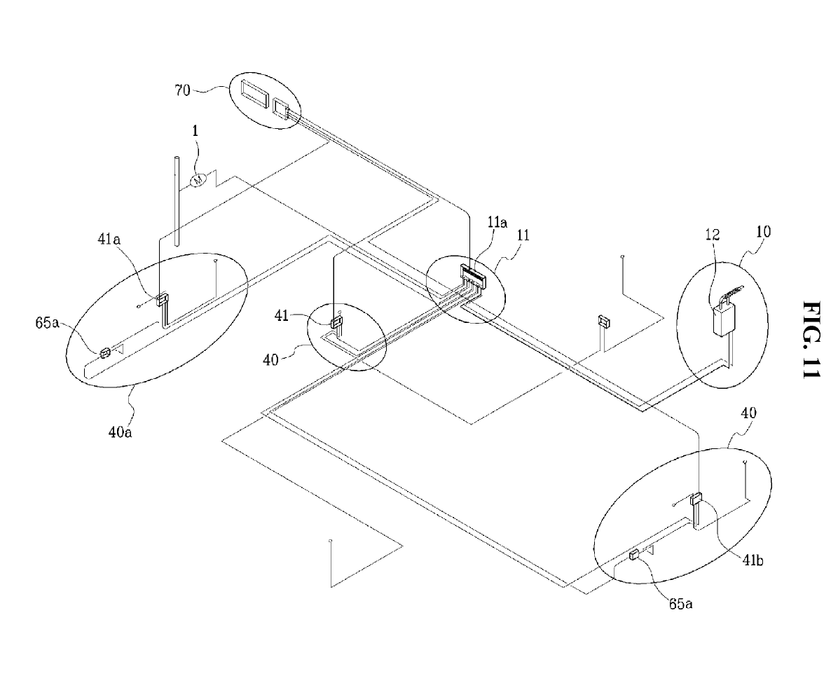

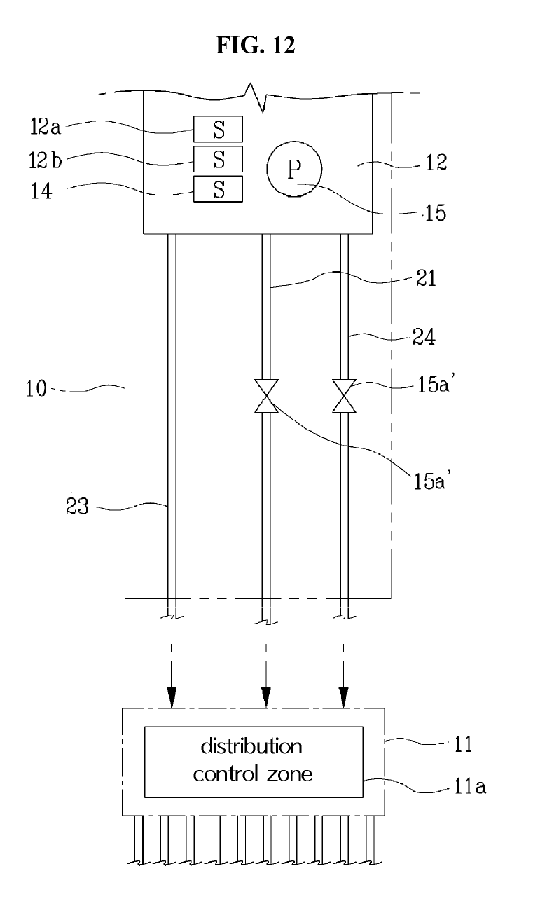

As shown in FIG. 11 and FIG. 12, the circulating water pipe 21, the cold water pipe 23 for supplying cold water, and the hot water pipe 24 for distributing hot water heated by the water heater 12 of the circulating water pumping control zone 10 extend between the water heater 12 and the distribution control zone 11.

In the water heater 12, a temperature sensor 12a and a flow rate sensor 12b are installed such that temperature sensor terminals 12a′ and flow rate sensor terminals 12b′ are connected to each other and can be operated in conjunction with each other. Therefore, the temperature leakage of water in the water heater 12 can be sensed by the temperature sensor 12a and the flow rate sensor 12b. A circulating water pump start switch 19 is installed at an appropriate location around the entrance of a bathroom or a faucet 30, so that, when the circulating water pump start switch 19 is turned on, the switch terminals of the water heater 12 are activated, thus starting the water heater 12. Therefore, mixed water having a temperature preset by thermo valves 18 provided in the respective control zones 40, 40a and 40b circulates through both the mixed water pipe 20 and the circulating water pipe 21. When the faucet 30 is opened, mixed water is discharged through the open faucet, so that pressure sensor terminals 14a′ of a pressure sensor 14 are inactivated and stop the operation of the hot water/circulating water pump 15 and stop the circulation of water in the circulating water pipe 21. However, when mixed water is continuously discharged through the faucet 30 in the above state, the water heater 12 is continuously operated. To control the flow control lever 31 of the faucet 30 and the operation of the water heater 12, the pressure sensor 14 having the pressure sensor terminals 14a′ is installed on the hot water pipe 24 at a location inside or outside the water heater and senses pressure inside the hot water pipe 24 according to the flow of hot water, and activates or inactivates the terminals of water heater operating and circulating water pump switches 7a, 7b and 7c.

The respective sensors 12a, 12b and 13, the respective terminals 12a′, 12b′ and 14a′ and the hot water circulation pump 15a, the hot water/circulating water pump 15 and the plurality of circulating water pump start switches 19 are connected to each other such that they can be operated in conjunction with each other, as shown in FIG. 12. The plurality of circulating water pump start switches 19 may be installed on one side of the door of a toilet entrance or on one side of a sink in a kitchen such that the switches 19 can be easily used by users.

When a user turns on one of the plurality of circulating water pump start switches 19 installed on one side of a toilet door or one side of a sink in a kitchen and opens the handle of a faucet 30 to use hot water, the flow rate sensor 12b inside the water heater 12 senses the flow rate of water flowing in the water heater 12 and the flow rate sensor terminals 12b′ are activated. Thus, the water heater 12 is ignited and the hot water/circulating water pump 15 starts operation and, at the same time, the hot water circulation pump 15a starts operation, hot water heated by the water heater 12 is fed to the distribution control zone 11.

Therefore, both the water heater 12 and the hot water/circulating water pump 15 can be operated by cooperation of the temperature sensor 12a, the temperature sensor terminals 12a′, the flow rate sensor 12b, the flow rate sensor terminals 12b′, the pressure sensor 14 and the pressure sensor terminals 14a′. Therefore, when using hot water, hot water and circulating water are selectively supplied such that mixed water can be immediately discharged from a faucet 30 and operation of the hot water circulation pump 15a can be efficiently controlled, thus saving energy.

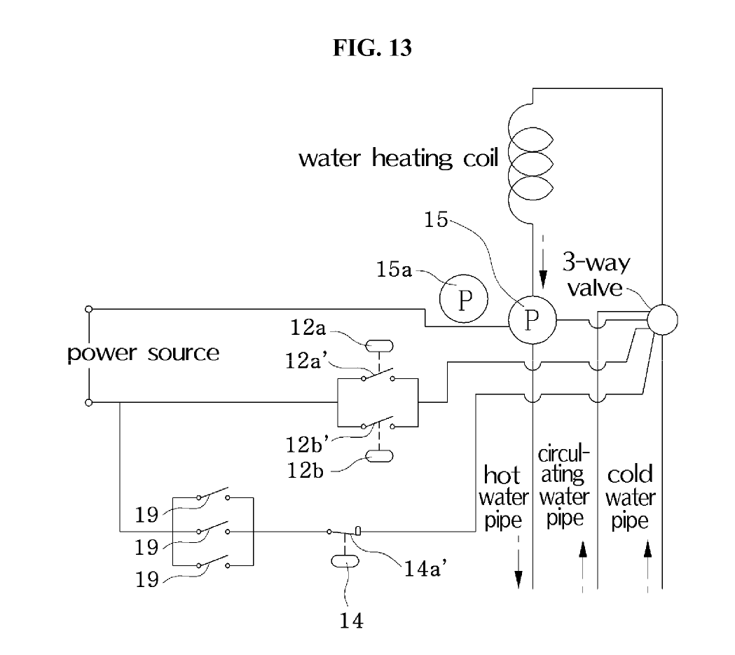

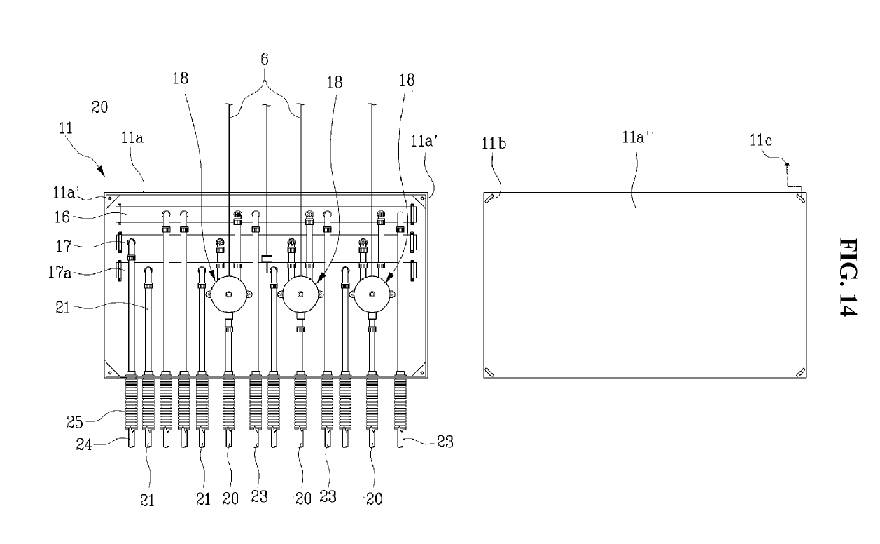

As shown in FIG. 13 and FIG. 14, the distribution control zone 11, to which hot water is supplied from the circulating water pumping control zone 10, is provided with a distribution control box 11a having both a circulating water distributing pipe 17a for supplying circulating water and thermo valves 18 each fabricated by integrating a step motor 18a with a thermostatic valve 18k into a single structure. The distribution control box 11a may be installed in a wall.

Alternatively, the distribution control box 11a may be installed in a ceiling panel of a toilet such that the control box 11a can be exposed outside the ceiling panel. As a further alternative, the distribution control box 11a may be installed in a wall at appropriate locations below a cupboard of a sink, a wardrobe or a wall closet in a dress room such that the distribution control box 11a is exposed outside the wall. The distribution control box 11a may be installed in the floor of a room.

The distribution control box 11a has a plurality of holes formed through the upper wall, lower wall, left side wall and right side wall. Further, the bellows double pipes 25 respectively surrounding the circulating water pipe 21, the cold water pipe 23 and the hot water pipe 24 are connected to the distribution control box 11a using respective connectors.

The cold water distributing pipe 16, the hot water distributing pipe 17 and the circulating water distributing pipe 17a installed in the distribution control box 11a are connected to the cold water pipe 23, the mixed water pipe 20 and the circulating water pipe 21 extending to respective control zones 40, 40a and 40b.

In the above-mentioned hot/cold water supply system, the cold water pipe 23, the mixed water pipe 20 and the circulating water pipe 21 are connected to the control zones 40, 40a and 40b by the respective distributing pipes 16, 17 and 17a in parallel such that cold water and mixed water can be supplied and distributed.

At an appropriate location below the circulating water distributing pipe 17a, a plurality of thermo valves 18 are provided for distributing mixed water produced by mixing cold water with hot water to the respective control zones 40, 40a and 40b.

Each of the thermo valves 18 is an integrated structure, in which a thermo valve body 18b having a cold water inlet port 18d, a hot water inlet port 18e and a mixed water outlet port 18f, a thermostatic valve 18k fitted into the thermo valve body 18b, and a five-phase or multi-phase step motor 18a mounted to the thermostatic valve 18k by a bracket 18c and used for controlling the temperature of mixed water are integrated into a single structure.

The thermostatic valve 18k has a well-known structure, in which the valve 18k is open in three directions, so that cold water and hot water flow into the valve through two openings and are mixed together in the valve 18k to produce mixed water prior to flowing from the valve 18k through a remaining one opening. When the temperature of mixed water is preset using a temperature setting lever 82, the preset temperature of mixed water can be adjusted by operation of a valve shaft 18g of the thermostatic valve 18k and the step motor 18a.

As shown in FIG. 14, the cold water distributing pipe 16 and the hot water distributing pipe 17 are connected using connection pipes 18h to the cold and hot water inlet ports 18d and 18e of the thermo valve body 18b assembled with the thermostatic valve 18k, so that cold water and hot water can be supplied to the thermo valve body 18b through the connection pipes 18h.

Here, a check valve 18j is installed between each of the connection pipes 18h and an associated one of the cold water distributing pipe 16 and the hot water distributing pipe 17, thus preventing reverse flow of cold water and hot water.

In the thermo valve 18, the valve shaft 18g fitted to the rotor 18i can be rotated by rotation of the multi-stage rotating step motor 18a, thus controlling the desired temperature of mixed water.

The cold water pipe 23 is connected to the cold water distributing pipe 16 so that cold water can be supplied to water heater 12 through the cold water distributing pipe 16 and, at the same time, the cold water can be supplied to the respective control zones 40, 40a and 40b and to the cold water inlet port 18d of the thermo valve 18.

Further, a control box cover 11a″ is mounted to the front of the distribution control box 11a, thus sealing the distribution control box 11a and producing the distribution control zone 11.

The control box cover 11a″ mounted to the front of the distribution control box 11a is provided with a longitudinal hole 11b at a location corresponding to a locking hole 11a′ formed in each of the distribution control box 11a, so that the control box cover 11a″ can be mounted to the distribution control box 11a using a locking member 11c. Here, the horizontality of the control box cover 11a″ can be realized by moving the control box cover 11a″ upwards, downwards, leftwards and rightwards using the longitudinal holes 11b.

The distribution control box 11a may be installed in a wall or may be installed in the floor of a room.

Further, the distribution control box 11a may be installed in a ceiling panel of a bathroom such that the box 11a is exposed outside or embedded in the ceiling panel. Further, the distribution control box 11a may be installed in a lower portion of a sink such that the box 11a is exposed.

Further, the distribution control box 11a may be installed in a wall closet in a dress room or may be installed in a wall of the water heater chamber such that the control box 11a is exposed outside the wall.

In the above-mentioned distribution control zone 11, a cold water pipe 23, a mixed water pipe 20 and a circulating water pipe 21 are connected to the control zones 40, 40a and 40b of a public bath, a kitchen and a private bath.

In the above description for the hot/cold water supply system of the present invention, pipes extend from one distribution control zone 11 to a plurality of control zones 40, 40a and 40b for a public bath, a kitchen and a private bath. However, it should be understood that a desired number of control zones in addition to the control zones 40, 40a and 40b for the public bath, the kitchen and the private bath may be connected to the distribution control zone 11 in parallel when necessary according to locations of the system and environmental conditions of the system.

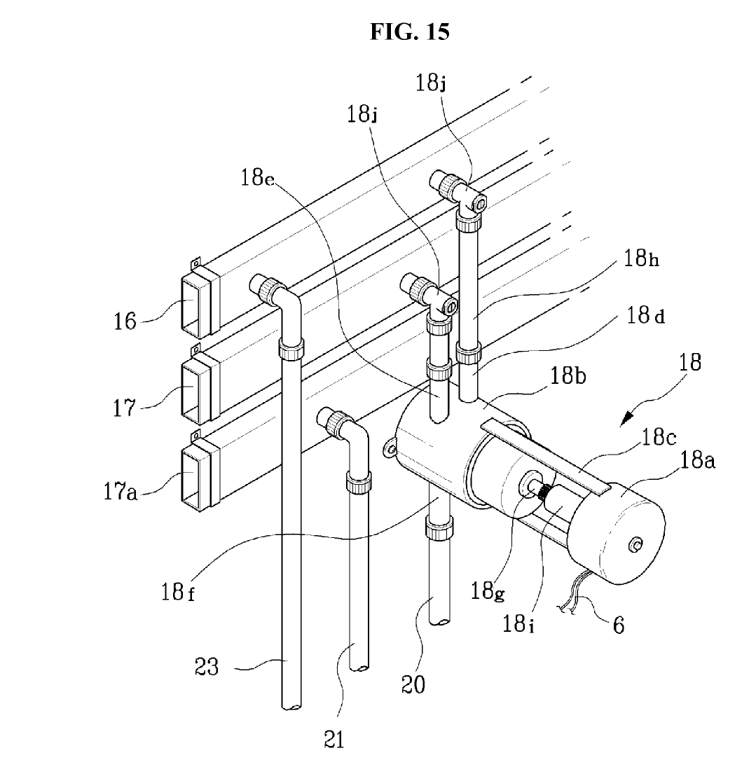

FIG. 15 is a perspective view of a public bath control zone 40a, which is one of the respective control zones connected to the distribution control zone 11 of the present invention.

The public bath control zone 40a is provided with a valve control box 41a, which includes a temperature setting lever 82 for controlling the temperature of mixed water supplied from the distribution control zone 11, a cold water/mixed water control valve 43 for distributing received mixed water and cold water, a shutoff valve 43′ for stopping the flow of discharged water, and a mixed water/circulating water pipe 52 therein.

Toilet control boxes 65a having different heights are installed at locations around the valve control box 41a and cold water pipes 23 extend from the toilet control boxes 65a to toilets 65a having different heights.

A plurality of holes are formed through the upper wall, lower wall, left side wall and right side wall of each of the valve control box 41a and the toilet control box 65a.

The cold water pipe 23, the mixed water pipe 20 and the circulating water pipe 21 are formed of flexible pipes and are covered with respective bellows double pipes 25, which are connected to the valve control box 41a and the toilet control box 65a using connectors.

A cold water inlet port 43a, a mixed water inlet port 43b and a cold water/mixed water outlet port 43c are formed in the cold water/mixed water control valve 43. The cold water inlet port 43a is connected to the cold water pipe 23 extending from the distribution control zone 11 to the toilet control box 65a. In the same manner, the mixed water inlet port 43b is connected to the mixed water pipe 20 extending from the distribution control zone 11, and the cold water/mixed water outlet port 43c is connected to the cold water/mixed water middle feed pipe 43d, through which cold water supplied through the cold water inlet port 43a or mixed water supplied through the mixed water inlet port 43b flows.

When necessary, the cold water pipe 23 connected to the cold water inlet port 43a of the cold water/mixed water control valve 43 may directly extend from the distribution control box 11a of the distribution control zone 11 without passing the toilet control boxes 65a having different heights.

Further, a cold water/mixed water inlet port 43′a and cold water/mixed water outlet ports 43′b and 43′c are formed in opposite ends of the shutoff valve 43′. The cold water/mixed water inlet port 43′a is connected to the cold water/mixed water middle feed pipe 43d through which cold water or mixed water flows under the control of the cold water/mixed water control valve 43. The cold water/mixed water outlet ports 43′b and 43′c formed in opposite ends of the shutoff valve 43′ are connected to the cold water/mixed water feed pipes through which cold water or mixed water flows to a bathtub or to a washstand. An elbow head 34 having a flow control lever 31 for controlling the flow of mixed water or cold water flowing toward the bathtub or to the washstand through the cold water/mixed water feed pipe is installed in a wall. A faucet 30 is mounted to the elbow head 34 and discharges mixed water or cold water to the bathtub or to the washstand.

Further, a mixed water/circulating water pipe 52 is provided at a side of the cold water/mixed water control valve 43 and branches from the mixed water pipe 20 connected to the mixed water inlet port 43b. A circulating water pipe 21 having the same diameter as that of the cold water pipe 23 or the mixed water pipe 20 is connected to the mixed water/circulating water pipe 52.

Here, the circulating water pipe 21 may have a diameter smaller than the diameter of the cold water pipe 23 or the diameter of the mixed water pipe 20.

A valve rotary shaft 47 is provided in front of both the cold water/mixed water control valve 43 and the shutoff valve 43′.

Further, a lever control panel 80 is installed in front of the valve control boxes 41, 41a and 41b. A temperature setting lever 82, a cold water/mixed water control lever 84 and a shutoff lever 86 are mounted in the lever control panel 80.

The temperature setting lever 82 is provided with a multi-terminal switch therein and is mounted to the lever control panel 80, with a DC electric wire 6 extending from the multi-terminal switch. The cold water/mixed water control lever 84 and the shutoff lever 86 are mounted to respective lever holes 87 formed in the lever control panel 80. Further, a lever shaft 84a, 86a formed in back of each of the cold water/mixed water control lever 84 and the shutoff lever 86 is connected to the valve rotary shaft 47 formed in front of each of the cold water/mixed water control valve 43 and the shutoff valve 43′.

Further, a lever extension rod 85 is mounted to each of the cold water/mixed water control lever 84 and the shutoff lever 86, which are mounted to the valve rotary shaft 47 provided in front of the cold water/mixed water control valve 43 and the shutoff valve 43′. Due to the lever extension rod 85, it is possible to control the length of the lever shaft according to thickness of a finished wall.

The temperature setting lever 82 is electrically connected to the respective thermo valves 18 of the distribution control zone 11 so that the step motors 18a of the thermo valves 18 installed in the distribution control box 11a of the distribution control zone 11 are operated in response to a temperature preset by the temperature setting lever 82 and rotate the valve shafts 18g fitted into the rotors 18i. Therefore, the thermo valve 18 can appropriately mix cold water and hot water with each other to produce mixed water having the preset temperature.

Further, the lever shaft 84a of the cold water/mixed water control lever 84 is connected to the valve rotary shaft 47 of the cold water/mixed water control valve 43, so that the cold water/mixed water control valve 43 can be opened or closed in response to leftward or rightward rotation of the cold water/mixed water control lever 84, thus selectively feeding cold water or mixed water.

Further, the lever shaft 86a of the shutoff lever 86 is connected to the valve rotary shaft 47 of the shutoff valve 43′, so that the shutoff valve 43′ can be opened or closed in response to leftward or rightward rotation of the shutoff lever 86, thus partially or totally stopping the flow of water for the washstand or the bathtub. Further, when it is desired to repair or change a faucet 30 provided in a control zone 40, 40a, 40b, only the flow of discharged water for the desired faucet 30 can be stopped without entirely stopping the flow of water for all the faucets 30 of the control zones 40, 40a and 40b.

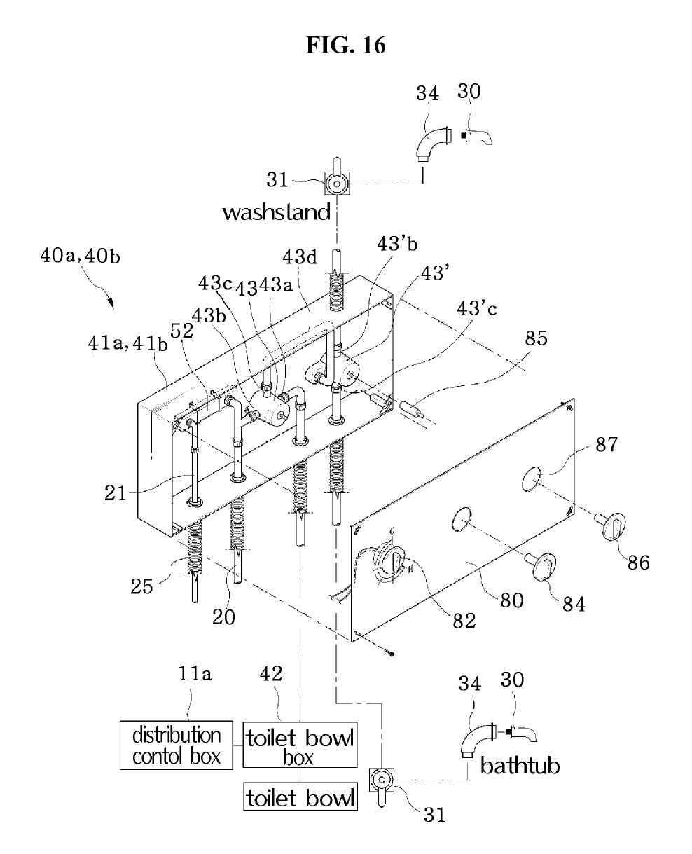

FIG. 16a is a view illustrating the normal flow of cold water or mixed water passing through the shutoff valve 43′ under the control of the shutoff lever 86 according to the second embodiment of the present invention.

FIG. 16b is a view illustrating the flow of cold water or mixed water passing through the shutoff valve 43′ under the control of the shutoff lever 86, in which the water path for the bathtub is closed but the water path for the washstand is opened. In the above state, because the water path for the bathtub is closed, it is possible to repair or change the pipes or the faucet 30 related to the bathtub.

FIG. 16c is a view illustrating the flow of cold water or mixed water passing through the shutoff valve 43′ under the control of the shutoff lever 86, in which the water path for the bathtub is opened but the water path for the washstand is closed. In the above state, because the water path for the washstand is closed, it is possible to repair or change the pipes or the faucet 30 related to the washstand.

FIG. 16d is a view illustrating the flow of cold water or mixed water passing through the shutoff valve 43′ under the control of the shutoff lever 86, in which the water paths for both the bathtub and the washstand are closed. In the above state, because the water paths for both the bathtub and the washstand are closed, it is possible to repair or change the pipes, the shutoff levers or the faucets 30 related to both the bathtub and the washstand at the same time.

As described above, the shutoff valve 43′ can selectively or entirely close the water paths for both the washstand and the bathtub in response to leftward and rightward rotation of the shutoff lever 86, so that it is easy to repair or change the mixed water pipes 20 and the faucets 30 related to the washstand or the bathtub after manipulating the shutoff lever 86 when there occurs leakage of water.

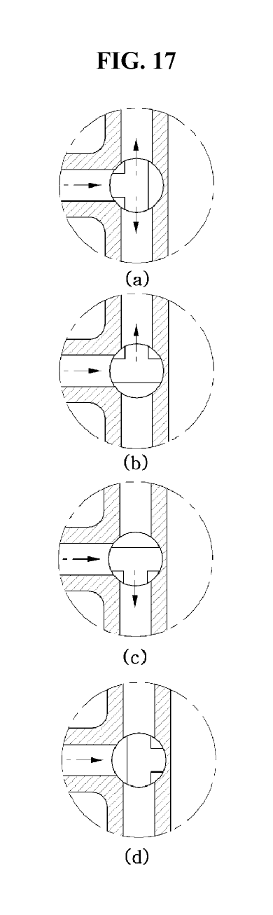

FIG. 17 is a perspective view illustrating a kitchen control zone 40 which is one of the control zones connected to the distribution control zone according to the second embodiment of the present invention.

The kitchen control zone 40 has a valve control box 41, in which a temperature setting lever 82 for controlling the temperature of mixed water distributed from the distribution control zone 11, a cold water/mixed water control valve 43 for distributing the received mixed water and cold water, and a shutoff valve 43′ for stopping the flow of discharged water are installed. The valve control box 41 of the kitchen control zone 40 has the same construction and function as those of the valve control box 41 of the public bath control zones 40a.

However, a laundry room control box is provided in a side of the valve control box 41 and may supply mixed water for automatic washing machine and hand washing facility.

Both the valve control box 41 and the laundry room control box constituting the kitchen control zone 40 are provided with a plurality of holes, which are formed through the upper, lower, left side and right side walls of the control boxes. The cold water pipe 23, the mixed water pipe 20 and the circulating water pipe 21 are formed of flexible pipes and are covered with respective bellows double pipes 25. The bellows double pipes 25 are connected to the holes of the valve control box 41 and the laundry room control box using respective connectors.

The cold water/mixed water control valve 43 installed in the valve control box 41 of the kitchen control zone 40 has the same construction and function as those of the cold water/mixed water control valve 43 installed in the valve control box 41 of the public bath control zone 40a. In other words, in the control valve 43 of the kitchen control zone 40, cold water or mixed water supplied thereto through the cold water inlet port 43a or the mixed water inlet port 43b flows therefrom through the cold water/mixed water outlet port 43c.

The cold water or mixed water distributed through the cold water/mixed water outlet port 43c flows through the cold water/mixed water middle feed pipe 43d.

A cold water/mixed water inlet port 43′a and cold water/mixed water outlet ports 43′b and 43′c are formed in the shutoff valve 43′. The cold water/mixed water middle feed pipe 43d is connected to the cold water/mixed water inlet port 43′a, so that cold water or mixed water discharged under the control of the cold water/mixed water control valve 43 can flow through the cold water/mixed water middle feed pipe 43d. Cold water/mixed water feed pipes are connected to the cold water/mixed water outlet ports 43′b and 43′c formed in opposite sides of the shutoff valve 43′ and feed cold water or mixed water to the sink or to the laundry room control box. An elbow head 34 having a flow control lever 31 for controlling the flow of mixed water or cold water flowing toward the sink through the cold water/mixed water feed pipe is installed in a wall. A faucet 30 is mounted to the elbow head 34 and discharges mixed water or cold water to the sink.

In the pipe extending to the laundry room control box, an elbow head 34 having a flow control lever 31 is installed in a wall. Further, a washing machine faucet 30 for discharging mixed water or cold water to a washing machine or a hand washing faucet 30 for discharging mixed water or cold water to a hand washing facility is mounted to the elbow head 34 installed in the wall.

When necessary, a flow control lever 5 may be provided between the controller 72 and a faucet 30 having a flow control lever.

A lever control panel 80, having a temperature setting lever 82, a cold water/mixed water control lever 84 and a shutoff lever 86, is mounted to the front of the valve control box 41 of the kitchen control zone 40. The temperature setting lever 82, the cold water/mixed water control lever 84 and the shutoff lever 86 have the same construction and function as those of the levers 82, 84 and 86 provided in the valve control box 41a of the public bath control zone 40a.

The lever control panel 80, having the temperature setting lever 82, the cold water/mixed water control lever 84 and the shutoff lever 86, may be installed in an upper plate of a sink such that the lever control panel 80 is exposed outside the upper plate, thus allowing a user to easily use the levers.

Each of the temperature setting levers 82 installed in the front surfaces of the valve control boxes 41, 41a and 41b of the present invention may be configured to set the temperature of discharged water between five stages which are C (cold water), 30° C., 35° C., 40° C., H (hot water) stages. Of course, the temperature stages, which can be selected by each of the temperature setting levers 82, may be divided into 6, 7, 8, 9, 10 or more stages including the C (cold water) and H (hot water) stages as desired by a user.

Further, each of the temperature setting levers 82 may be manually controlled between the stages as described above. However, a digital switch (not shown) having an LCD panel (not shown) may be replaced with each of the temperature setting levers 82. In other words, the setting of temperature in the present invention may be realized through an analog method, a digital method or an input number method.

Further, in the above-description, the cold water/mixed water control levers 84 and the shutoff levers 86 are manually controlled to operate the valves. However, the valves manually controlled by the levers may be connected to respective motors (not shown) by respective valve rotary shafts 47 such that the valves can be motor-operated.

Therefore, the lever control panel 80 having the temperature setting lever 82, the cold water/mixed water control lever 84 and the shutoff lever 86 is electrically connected to both the distribution control zone 11 and the main control zone 70 such that the motor can be automatically controlled and a desired amount of water having a preset temperature can be discharged through a plurality of faucets 30.

The controller 72 provided in the main control zone 70 of the present invention is electrically connected through electric wires 6 to the water heater 12, the electronic control valve 15a′ and the hot water/circulating water pump 15 installed in the circulating water pumping control zone 10, and to the plurality of step motors 18a driving the thermo valves 18 installed in the distribution control zone 11, and to the temperature setting levers 82 provided in the respective control zones 40, 40a and 40b. Therefore, the hot/cold water supply system of the present invention can controlled by the controller 72 such that desired amounts of mixed water having temperatures preset by the temperature setting levers 82 provided in the respective control zones 40, 40a and 40b can be discharged through a plurality of faucets 30.

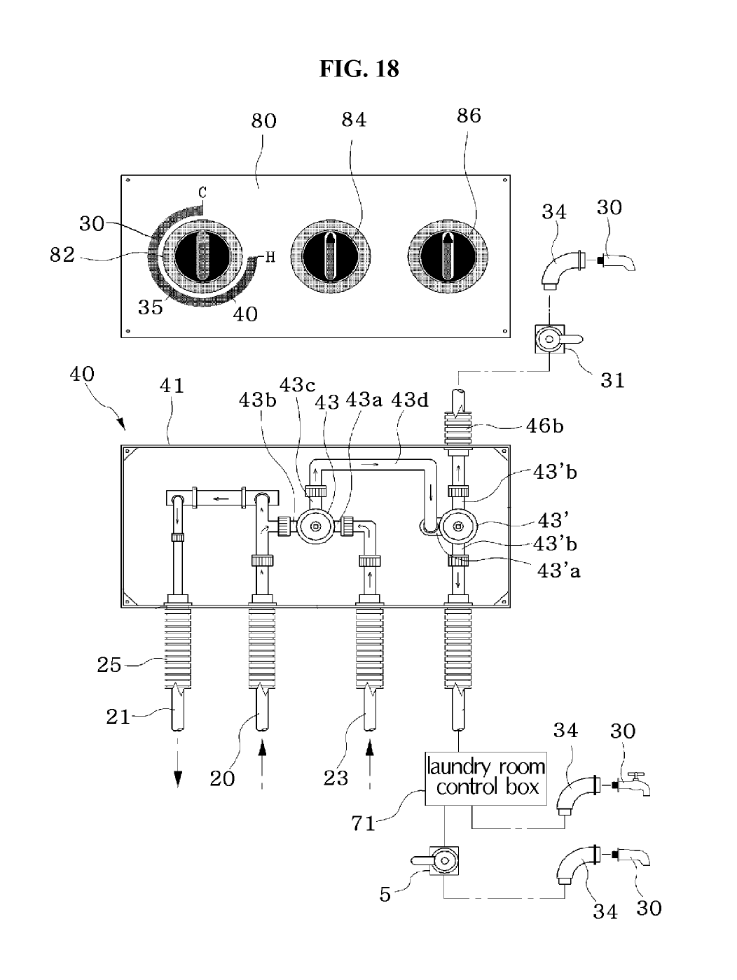

FIG. 18 is a perspective view illustrating a distribution control box constituting the distribution control zone according to a modification of the second embodiment of the present invention. As shown in the drawing, an extension member 110 is provided in front of the distribution control box 11a for adjusting thickness of the distribution control box 11a according to a variation in thickness of an interior finish material.

The extension member 110 has small thickness and the same circumference as that of the distribution control box 11a, and is mounted to the distribution control box 11a using locking screws 101 such that thickness of the distribution control box 11a can be adjusted by the extension member 110.

Further, when the control box cover 11a″ and the extension member 110 are mounted to the distribution control box 11a using locking screws 101, there may occur a misalignment of the locking holes formed in the corners of the control box cover 11a″, the extension member 110 and the distribution control box 11a. Further, the distribution control box 11a may be installed askew in the wall. In the above state, to realize horizontality of the control box cover 11a″ by moving the control box cover 11a″ clockwise or counterclockwise, the locking holes formed in the corners of the control box cover 11a″ for receiving the locking screws 101 are designed as longitudinal holes.

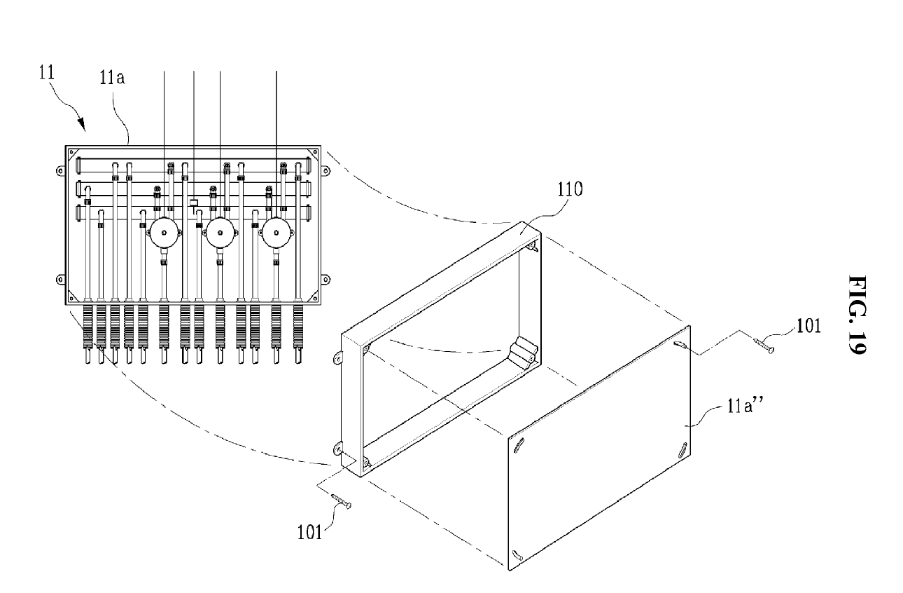

FIG. 19 is a perspective view illustrating a valve control box constituting the control zones according to a modification of the second embodiment of the present invention. As shown in the drawing, when the depth of a recess formed in a wall for receiving a valve control box 41, 41a or 41b is increased due to an increase in thickness of a finish material, an inner cover 120 may be interposed between the extension member 110 and the valve control box 41, 41a or 41b.

The extension member 110 has small thickness and the same circumference as that of the valve control box 41, 41a or 41b and is mounted to the valve control box 41, 41a or 41b using locking screws 101 such that thickness of the valve control box 41, 41a or 41b can be adjusted by the extension member 110.

The inner cover 120 may be mounted to the front of the valve control box 41, 41a or 41b using the locking screws 101 or, when the extension member 110 is mounted to the valve control box 41, 41a or 41b, the inner cover 120 may be mounted to the extension member 110 using the locking screws 101. When the extension member 110 and the inner cover 120 are mounted to the valve control box 41, 41a or 41b using the locking screws 101, there may occur a misalignment of the locking holes formed in the corners of the extension member 110, the inner cover 120 and the valve control box 41, 41a or 41b. Further, the valve control box 41, 41a or 41b may be installed askew in the wall. In the above state, to realize horizontality of the inner cover 120 by moving the inner cover 120 clockwise or counterclockwise, the locking holes 121 formed in the corners of the inner cover 120 for receiving the locking screws are designed as longitudinal holes.

Further, the inner cover 120 has an approach opening 122 for allowing easy approach of a worker's hand or a working tool when it is required to repair the parts inside the valve control box, such as due to leakage of water, after finishing the interior finish work. Further, a plurality of frictional protrusions 123 may be formed on the outer surface of the inner cover 120 and allows mortar or tiles to be easily attached to the inner cover 120.

The edge 124 of the approach opening 122 protrudes to a height to which mortar or tiles may reach when the mortar or tiles are attached to the inner cover 120. The edge 124 of the opening 122 is provided with three locking holes 125 for mounting the lever control panel 80 of the present invention to the edge 124 using locking screws 101. In the present invention, it is preferred that one locking hole be formed in the lower edge and two locking holes be formed in the upper edge such that horizontality of the lever control panel 80 can be realized by moving the panel 80 clockwise or counterclockwise based on the locking hole formed in the lower edge.

Therefore, as described above, the valve control box 41 of the kitchen control zone 40 and the valve control box 41b of the private bath control zone 40b may be installed with the extension member 110 and/or the inner cover 120.

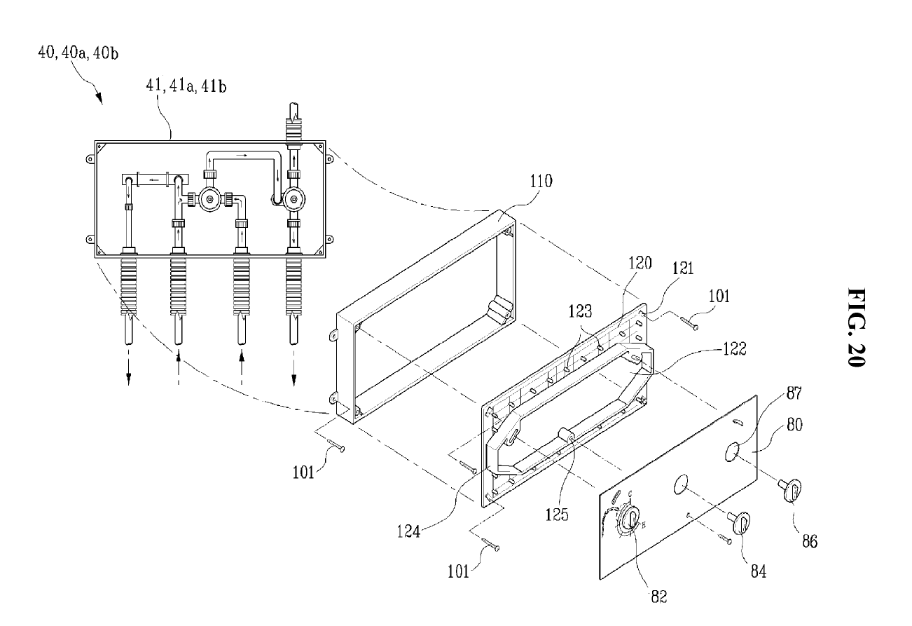

FIG. 20 is a view illustrating a series piping according to the second embodiment of the present invention. As shown in the drawing, the hot/cold water supply system of a water heater 12 with both a cold water pipe 23 and a hot water pipe 24 connected to the water heater 12 according to the present invention comprises: a circulating water pumping control zone 10′ for producing hot water heated by the water heater 12; a distribution control zone 11 having a distribution control box 11a which includes a cold water distributing pipe 16 for distributing cold water supplied from the cold water pipe 23, a hot water distributing pipe 17 for distributing hot water supplied from the hot water pipe 24, and a thermo valve 18 fabricated by integrating a step motor 18a with a thermostatic valve 18k into a single structure;

a public bath control zone 40a having a valve control box 41a, which includes a temperature setting lever 82 for controlling the temperature of mixed water supplied from the distribution control zone 11, a cold water/mixed water control valve 43 for distributing received mixed water and cold water, and a shutoff valve 43′ for controlling the flow of discharged water;

a kitchen control zone 40 having a valve control box 41, which includes a temperature setting lever 82 for controlling the temperature of mixed water supplied from the public bath control zone 40a, a cold water/mixed water control valve 43 for distributing received mixed water and cold water, and a shutoff valve 43′ for controlling the flow of discharged water;

a private bath control zone 40b having a valve control box 41b, which includes a temperature setting lever 82 for controlling the temperature of mixed water supplied from the kitchen control zone 40, a cold water/mixed water control valve 43 for distributing received mixed water and cold water, and a shutoff valve 43′ for controlling the flow of discharged water; and

a main control zone 70 having a controller 72, which is electrically and electronically connected to the circulating water pumping control zone 10, the distribution control zone 11 and the respective control zones 40, 40a and 40b, thus controlling operation of water heater 12 and the amount and temperature of the mixed water when the mixed water is used, wherein the control zones 40, 40a and 40b are connected to each other in series.

In the same manner as that described for the hot/cold water supply system in which the control zones are connected to each other in parallel, the hot/cold water supply system in which the control zones are connected to each other in series is advantageous in that it does not require a plurality of thermo valves 18 for feeding mixed water to respective control zones 40, 40a and 40b, but requires only one thermo valve 18 installed in the distribution control box 11a and connects the distribution control box 11a to the valve control box 41a of the public bath control zone 40a in series, connects the valve control box 41a of the public bath control zone 40a to the valve control box 41 of kitchen control zone 40 in series, and connects the valve control box 41 of the kitchen control zone 40 to the valve control box 41b of private bath control zone 40b in series, so that the hot/cold water supply system can feed mixed water to respective valve control boxes 41, 41a and 41b of the plurality of control zones 40, 40a and 40b using one thermo valve 18.

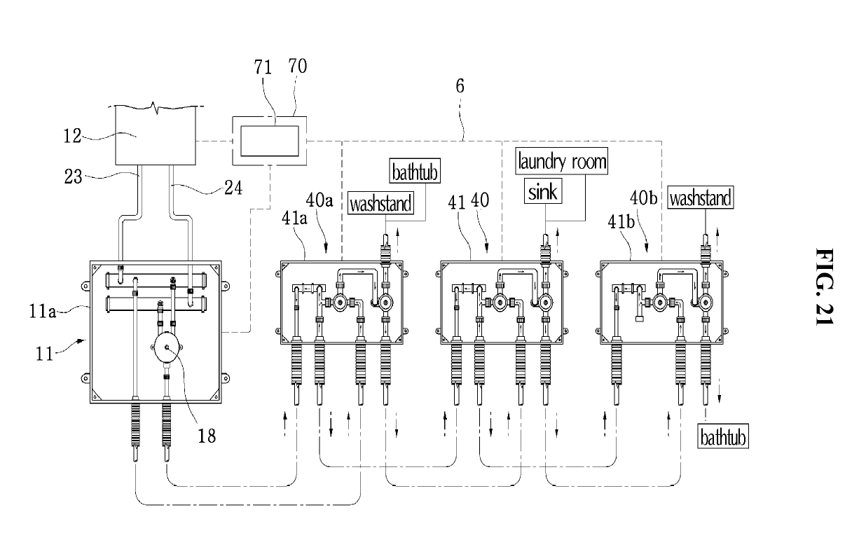

FIG. 21 is a view illustrating a series piping according to a modification of the second embodiment of the present invention. As shown in the drawing, the thermo valve 18, which receives cold water and hot water and supplies mixed water, is installed between the cold water pipe 23 and the hot water pipe exposed outside the lower end of the water heater 12. Further, both the cold water pipe 23 and the mixed water pipe 20 for feeding mixed water supplied from the thermo valve 18 are connected to one of the valve control boxes 41, 41a and 41b of the public bath control zone 40a, the kitchen control zone 40 and the private bath control zone 40b and, at the same time, the valve control boxes 41, 41a and 41b are connected to each other in a series, thus providing a hot/cold water supply system, which has a simple pipeline structure and is convenient to use.

Each of the step motor 18a of the thermo valve 18 installed in the distribution control box 11a and the step motor 18a of the thermo valve 18 exposed outside the lower end of the water heater 12 are connected to the temperature setting levers 82 of the valve control boxes 41, 41a and 41b provided in respective control zones 40, 40a and 40b and to the controller 72 of the main control zone 70 using electric wires 6, so that the hot/cold water supply system can be controlled by the controller 72. Further, in the hot/cold water supply system, desired amounts of mixed water having temperatures preset by the temperature setting levers 82 of the valve control boxes 41, 41a and 41b of the respective control zones 40, 40a and 40b can be discharged through the plurality of faucets 30, so that a user can easily use mixed water.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A hot/cold water supply system of a water heater, in which a temperature of discharged water can be easily controlled and both a cold water pipe and a hot water pipe are connected to the water heater, the system comprising:
a circulating water pumping control zone, in which a pressure sensor and a hot water/circulating water pump having a three-way valve are installed on respective pipes extending from the water heater, so that, when using hot water, circulation of hot water and circulating water can be controlled by turning on a circulating water pump start switch, and when using hot water exclusively, the water heater and the hot water/circulating water pump are operated to supply hot water so that mixed water can be instantaneously discharged, thus saving water and energy;
a distribution control zone, which includes a cold water distributing pipe for distributing cold water discharged from the cold water pipe, a hot water distributing pipe for distributing hot water discharged from the hot water pipe, and a distribution control box provided with a plurality of thermo valves each fabricated by integrating a step motor with a thermostatic valve;
a plurality of control zones, which include respective valve control boxes having respective temperature setting levers controlling the step motors of the respective thermo valves such that the temperature of mixed water discharged from the distribution control zone can be controlled, respective cold water/mixed water control valves for distributing mixed water and cold water having predetermined temperatures, and respective shutoff valves for controlling the flow of discharged water;
a plurality of faucets having respective flow control levers and respective cold water/mixed water control levers controlling the flow of mixed water and cold water supplied from the control zones; and
a main control zone having a controller electrically and electronically connected to the circulating water pumping control zone, the distribution control zone and the respective control zones and controlling operation of the water heater and the temperature of the mixed water when using the hot water/mixed water, wherein the respective control zones are coupled to each other in parallel, so that, when the circulating water pump start switch is operated, the three-way valve is opened both toward the circulating water pipe and toward the hot water pipe, and both the water heater and the circulating water pump are activated, and thereby hot water heated in the water heater flows to the thermo valves through the hot water pipe and produces mixed water having a predetermined temperature and is discharged through the faucets, and wherein, when the faucets are opened, pressure inside a pipeline is reduced and terminals of the pressure sensor are turned off, so that openings of the three-way valve toward both the circulating water pipe and the hot water pipe are closed and, at the same time, the three-way valve is opened toward the hot water pipe by way of both the cold water pipe and a hot water heating coil installed in the water heater, so that hot water/mixed water can be continuously discharged, and wherein, when the flow control levers provided in the faucets are closed, the operation of the water heater is stopped, so that the mixed water can be immediately discharged without uselessly consuming cold water, thereby saving water.

2. The hot/cold water supply system as set forth in claim 1, wherein the control zones comprise at least two control zones installed at each home, and a check valve is installed in an outlet port of a circulating water joining pipe at a location before the flow of water from the valve control boxes is joined to the circulating water joining pipe through the respective circulating water pipes, so that hot water or mixed water having different temperatures can be prevented from reverse flowing to another valve control box through the hot water/mixed water pipe, and thereby, even when a user uses hot water having a desired temperature by controlling the thermo valve installed in the valve control box of a control zone and, at the same time, another user uses hot water having a temperature higher than 50° C. by controlling the thermo valve installed in the valve control box of another control zone, the hot water used in the control zone can be prevented from reverse flowing to the valve control box of the control zone through the circulating water pipe and the temperature of hot water or mixed water discharged to a user from being suddenly changed.

3. The hot/cold water supply system as set forth in claim 2, wherein the respective control zones comprise:
a public bath control zone having a valve control box, which is provided with a temperature setting lever for controlling the temperature of mixed water supplied from the distribution control zone and a cold water/mixed water control valve for distributing received mixed water and cold water, and a shutoff valve for controlling the flow of discharged water;
a kitchen control zone having a valve control box, which is provided with a temperature setting lever for controlling the temperature of mixed water supplied from the public bath control zone, a cold water/mixed water control valve for distributing received mixed water and cold water, and a shutoff valve for controlling the flow of discharged water; and
a private bath control zone having a valve control box, which is provided with a temperature setting lever for controlling the temperature of mixed water supplied from the kitchen control zone, a cold water/mixed water control valve for distributing received mixed water and cold water, and a shutoff valve for controlling the flow of discharged water.

4. The hot/cold water supply system as set forth in claim 3, wherein the public bath control zone and the private bath control zone are configured such that a mixed water pipe having a bellows double pipe structure is installed at an appropriate location in a wall having a toilet and feeds hot water or mixed water having a preset temperature flowing from the valve control box, and a cleaning spray having a flow control button is installed on the wall after finishing interior finish work and is connected to the mixed water pipe by a metal spray hose, so that a user can use the cleaning spray for washing his/her body with discharged water having the preset temperature after relieving oneself.

5. The hot/cold water supply system as set forth in claim 1, wherein, when a predetermined time goes by after the circulating water pump start switch has been turned on, the switch is automatically turned off and stops operation of the circulating water pump, and when the faucet is closed after using hot water/mixed water, pressure inside the pipeline is increased, so that, although the terminals of the pressure sensor are kept in an activated state, both the water heater and the circulating water pump are stopped, thus being prevented from being continuously operated.

6. The hot/cold water supply system as set forth in claim 1, wherein the respective control zones are configured such that the control zones can supply cold water, hot water and mixed passing through the cold water/mixed water control valves installed in the respective water valve control boxes to respective faucets or can selectively stop the flow of water to the faucets, so that, when a faucet is broken or a pipe installed in a control zone leaks water, the flow of water to the faucet or to the control zone can be independently stopped, thus allowing the remaining faucets or the remaining control zones to be used.

7. The hot/cold water supply system as set forth in claim 1, wherein one hot water/mixed water pipe or one cold water pipe is installed in one pipeline in a way such that hot water, mixed water or cold water can be immediately supplied to a user without separately installing the cold water pipe for feeding cold water or the mixed water pipe for feeding hot water or mixed water in walls or floors having faucets connected to the respective control zones at each home, so that the number of pipes installed is reduced, thus realizing structural stability of the walls and floors.

8. The hot/cold water supply system as set forth in claim 1, wherein the cold water pipe, the hot water/mixed water pipe and the circulating water pipe are connected to the valve control boxes of the respective control zones in a bellows double pipe structure such that the pipes are connected to each other in a branching, distributing and loop style, thus having a distributing function.

9. The hot/cold water supply system as set forth in claim 1, wherein the valve control boxes of the control zones are provided with respective thermo valves and the temperature of discharged water is manually controlled, so that cold water, hot water and mixed water can be discharged from the plurality of faucets of the valve control boxes installed at each home under the manual control.

10. A hot/cold water supply system of a water heater, in which a temperature of discharged water can be easily controlled, the system comprising:
a water heater producing hot water by heating cold water;
a distribution control zone having a cold water distributing pipe for distributing cold water supplied from a cold water pipe, a hot water distributing pipe for distributing hot water supplied from the water heater, and a plurality of thermo valves controlling the temperature of discharged water under the manual control; and
a plurality of control zones having respective valve control boxes provided with respective cold water/mixed water control valves for receiving both mixed water from the thermo valves of the distribution control zone and cold water from the cold water pipe, and supplying the cold water and the mixed water to the plurality of faucets.

11. The hot/cold water supply system as set forth in claim 1, further comprising:
a manifold pipe installed in each of the valve control boxes of the respective control zones, wherein a hot water/mixed water branching pipe having a plurality of inlet/outlet ports is provided in one side of the manifold pipe, a cold water branching pipe having at least two inlet/outlet ports is provided in another side of the manifold pipe, and a cold water/mixed water control valve having a motor is provided in the center of the manifold pipe, and the cold water pipes of the respective control zones are connected to each other in a loop parallel style, so that, when at least two faucets discharge cold water at the same time in each home, the cold water can be supplied in two directions, thus minimizing a variation in the flow rate of the cold water.

12. A hot/cold water supply system of a water heater, in which a temperature of discharged water can be easily controlled, the system comprising:
a distribution control box installed in a wall and connected to pipes having a double pipe structure, the distribution control box having therein a cold water distributing pipe for distributing cold water supplied through a cold water pipe, a hot water distributing pipe for distributing hot water supplied through a hot water pipe, a circulating water distributing pipe for distributing circulating water, and a plurality of thermo valves each fabricated by integrating a step motor with a thermostatic valve into a single structure, wherein a control box cover is mounted to the front of the distribution control box using locking members.

13. The hot/cold water supply system as set forth in claim 12, further comprising:
an extension member having predetermined thickness and the same circumference as that of the distribution control box, and mounted to the front of the distribution control box using locking screws, thus adjusting the thickness of the distribution control box.

14. The hot/cold water supply system as set forth in claim 12, wherein the distribution control box is installed in a ceiling panel of a toilet.

15. The hot/cold water supply system as set forth in claim 12, wherein the distribution control box is installed in a ceiling panel of a toilet such that the distribution control box is exposed outside the ceiling panel.

16. The hot/cold water supply system as set forth in claim 12, wherein the distribution control box is installed in a bottom of one of a sink, a wall closet, a dress room and a shoes cabinet.

17. The hot/cold water supply system as set forth in claim 12, wherein each of the valve control boxes is assembled with a lever control panel connected to the temperature setting lever controlling the temperature of mixed water, the cold water/mixed water control valve and the shutoff valve controlling the flow of discharged water, wherein the valve control boxes are installed in walls having the faucets in a toilet, a sink and a laundry room and have a double pipe structure, and have respective branching functions, so that the valve control boxes can branch to each other.

18. The hot/cold water supply system as set forth in claim 12, wherein each of the temperature setting levers are manually operated or are fabricated using digital switches having LCD panels so that the temperature of discharged water can be controlled through an analog method, a digital method or an input number method.

19. The hot/cold water supply system as set forth in claim 12, wherein each of the temperature setting levers installed in the front of the valve control boxes is configured to set the temperature of discharged water between five stages which are C (cold water), 30° C., 35° C., 40° C., H (hot water) stages, or between six or more stages, which are six, seven, eight, nine, ten or more stages including the C (cold water) and H (hot water) stages, as desired by a user.

20. The hot/cold water supply system as set forth in claim 12, wherein the faucets are connected to the respective thermo valves such that the faucets can discharge cold water and hot water having temperatures controlled by operation of the respective step motors, wherein the flow control levers for controlling the flow of cold water or hot water are separated from the respective faucets and installed in walls or are integrated with the respective faucets into single structures.

21. The hot/cold water supply system as set forth in claim 1, wherein each of the cold water/mixed water control valves and the shutoff valves operated by manual rotation of the cold water/mixed water control levers and the shutoff levers is fabricated by assembling a motor with a valve rotary shaft and is controlled by operation of the motor.

22. A hot/cold water supply system of a water heater, in which a temperature of discharged water can be easily controlled, the system comprising:
a circulating water pumping control zone for producing hot water heated by the water heater;
a distribution control zone having a distribution control box which includes a cold water distributing pipe for distributing cold water supplied from a cold water pipe, a hot water distributing pipe for distributing hot water supplied from a hot water pipe, and a thermo valve fabricated by integrating a step motor with a thermostatic valve into a single structure;
a public bath control zone having a valve control box, which includes a temperature setting lever for controlling the temperature of mixed water supplied from the distribution control zone, a cold water/mixed water control valve for distributing received mixed water and cold water, and a shutoff valve for controlling the flow of discharged water;
a kitchen control zone having a valve control box, which includes a temperature setting lever for controlling the temperature of mixed water supplied from the public bath control zone, a cold water/mixed water control valve for distributing received mixed water and cold water, and a shutoff valve for controlling the flow of discharged water;
a private bath control zone having a valve control box, which includes a temperature setting lever for controlling the temperature of mixed water supplied from the kitchen control zone, a cold water/mixed water control valve for distributing received mixed water and cold water, and a shutoff valve for controlling the flow of discharged water; and
a main control zone having a controller, which is electrically and electronically connected to the respective valve control boxes of the circulating water pumping control zone, the distribution control zone and the respective control zones, thus controlling operation of water heater and the amount and temperature of the mixed water when the mixed water is used, wherein the valve control boxes of the control zones are connected to each other in series.

23. The hot/cold water supply system as set forth in claim 22, wherein the thermo valve is installed between the cold water pipe and the hot water pipe exposed outside a lower end of the water heater, and both the cold water pipe and a mixed water pipe for feeding mixed water supplied from the thermo valve are connected to one of the valve control boxes of the public bath control zone, the kitchen control zone and the private bath control zone and, at the same time, the valve control boxes are connected to each other in a series.
